(19) United States
(12) Patent Application Publication
(10) Pub. No.: US 2015/0379443 A1
(43) Pub. Date: Dec. 31, 2015

(54) SYSTEM AND METHOD FOR ENTERPRISE RISK MANAGEMENT

(71) Applicant: George Whitney, Carmichael, CA (US)

(72) Inventor: George Whitney, Carmichael, CA (US)

(21) Appl. No.: 14/318,465

(22) Filed: Jun. 27, 2014

(51) Int. Cl. G06Q 10/06; G06Q 10/10

(52) U.S. Cl. CPC G06Q 10/0637; G06Q 10/0635; G06Q 10/103

(57) ABSTRACT

A system and apparatus for establishing, evaluating, managing and enhancing risk management programs. One primary embodiment of the system is the capability to integrate, organize and affect all requisite program factors, processes and outcomes using a simple, unified program dashboard and associated toolset.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2014, Complete EM®, All Rights Reserved.

### TECHNICAL FIELD

This patent application relates to computer-implemented software, networked systems, and data processing systems according to one embodiment, and more specifically to systems and methods for enterprise risk management.

### BACKGROUND

Organizations strive to manage risk as one of several means to achieve and maintain success. Unfortunately, the number and nature of factors inherent in the practice of risk management (i.e., the variety of hazards and threats, requirements and best practices, enterprise policies and procedures, resources and resource constraints, stakeholder relationships, etc.), render the work complicated, time-consuming, expensive or otherwise impractical to accomplish in total. Enterprise risk, therefore, is often managed in a limited or ad-hoc manner, which can result in greater harm to an organization when a risk-induced event (i.e., emergency) occurs, as well as to the people, property, environment, and community surrounding or affected by the organization.

The notion of risk management is far from novel. Several well-established processes and tools now apply to this practice of art. However, five (5) different circumstances render existing processes and tools only marginally effective or prohibitively expensive to use. They are:
a. Many risk managers have 100-200 separate program outcomes to accomplish, which necessitates work that is difficult to define, organize, and accomplish;
b. Organizations define risk and program success differently, which typically requires program customization including adaptations of performance metrics, processes, tools, and outputs;
c. Complex interdependencies exist between risks, risk management activities, and outcomes, which necessitates dynamic risk modelling, flexible program management, task integration, and thoughtful outcome management;
d. Effective risk management requires the engagement and collaboration of many if not all units within an organization, which often proves difficult to accomplish; and
e. Risk managers own, control, direct or influence a disproportionately small number of resources relative to their scope of program responsibility, so the streamlining of processes and application of force multipliers are necessary to accomplish all necessary work.

### SUMMARY

The various embodiments described herein help users create, visualize, and effectively manage a comprehensive enterprise risk management program. By focusing on both the typical tasks and contemporary challenges inherent in the practice of risk management, the various embodiments described herein advance the profession by allowing risk managers to better define success, achieve and maintain awareness of their entire program status, understand the inputs, processes, tools and outputs necessary to develop or enhance a program, and to accomplish specific tasks that may be critical to program success. Specifically, but not inclusive of all embodiments described herein, system users collect, analyze, and share relevant program information; select, customize, and apply program performance metrics; define individual program success and shortfalls; develop program priorities, strategies, and work planning; manage projects, supporting tasks and activities; engage program sponsors, stakeholders and peers; conduct research; report program status and progress; develop important program documents; and manage separate phases of risk management activity. Additionally, the various embodiments described herein relate risk management program activity to factors of program success which allow users to measure and report the earned-value of each risk management activity they undertake and, ultimately, their overall program readiness. One primary embodiment is a simple, integrated, and contextualized program dashboard used to summarize risk management program status, share and analyze important program information, and effect program enhancements.

### DEFINITION OF TERMS

The following terms and related meanings are used in this disclosure:
a. AJAX—Asynchronous Javascript and XML is a technology developed by Microsoft® to exchange data between Web clients and servers concurrently as users interact in other ways with a page. AJAX operates “in the background” as a means to improve performance as browsers render Web pages.
b. ASP.NET—A server-side Web application framework developed by Microsoft® that, among other features, facilitates the use of dynamic Web pages.
c. COM—Component Object Model, a technology developed by Microsoft® that facilitates the creation of common objects used between different software processes.
d. Dashboard—An analog or digital technique and tool used to quickly share information with a user by displaying summarized or compiled information in one or more views.
e. Force-Multiplier—A term used to describe something that creates the effect of greater numbers, force or effect.
f. GUI—Graphical User Interface, a means of interacting with a computer device by way of both text and graphic objects.
g. HTTP—Hypertext Transfer Protocol, a structured language used as the basis for communication across the Web
h. HTTPS—Hypertext Transfer Protocol—Secure, the result of using HTTP over the SSL/TLS protocol to create a means of secure communications.
i. Hyperlink—A relationship created between text or graphic elements on one page to a Web page
j. LAN—A network of interconnected computers that share resources at a particular location.
k. MMS—Multimedia Messaging Service, a process for transmitting and receiving multimedia messages to and from a mobile device.
l. MVC—A software architecture that divides an application into three parts: models that consist of data, logic and rules; views that display data and enable user interaction; and controllers that accept instructions to then act on views or models.
m. Open XML—A technology developed by Microsoft that uses a zipped XML file format to save Microsoft Office® products.
n. Phase—One of six categories of risk management program development activity.
o. Primer—A brief description of an issue or concept used to quickly provide a reader with a comprehensive, albeit general understanding of a topic.
p. Risk—A term used to describe the sum of all potential consequences of exposure to a hazard or threat. Risk can be described as a function of probability, vulnerability and impact.
q. RDMS—Relational Database Management System, a system for storing data in tables that consist of rows and columns. Such a system provides a way to relate and operate on various elements of data
r. Readiness—The state of being reasonably ready for a risk-induced event.
s. RSS—Really Simple Syndication, the use of Web feed formats to automatically publish XML data, so that subscribers can automatically receive information.
t. SaaS—Software as a Service, a software business model characterized by the centralized Web hosting of a software application and a subscription program by which software users gain access to and use software via the Web.
u. SMS—Short Message System, a technology used to send 160-character text messages over telephony networks
v. SSL/TLS—The computer system protocol that uses of a certificate and cryptographic keys to authenticate a client to a server, thereby controlling access and providing security from eavesdropping and hacking
w. Wiki—An interactive Web repository maintained by a user community to share an expanding body of reference information.
x. XML—Extensible Markup Language, a language used in computer systems that is easily readable by both computer software and humans.

### BRIEF DESCRIPTION OF THE DRAWINGS

The various embodiments are illustrated by way of example, and not by way of limitation, in the figures of the accompanying drawings in which:

FIG. 1 is a block diagram that illustrates four types of risk management program outcomes, specific examples of each outcome, and the relationship of each type of outcome to the success of a risk management program.

FIG. 2 is a block diagram that illustrates the overall process of risk management and the linear, iterative, and cyclical nature of this work.

FIG. 3 is a block diagram that illustrates the interdependent relationships of program outcomes.

FIG. 4 is a diagram that illustrates the disproportionately small scale of resources typically available to enterprise risk managers and how they are challenged to work with many stakeholders to achieve various program outcomes.

FIG. 5 is a diagram that illustrates the risk manager's role in bridging stakeholder communication and coordination.

FIG. 6 is a diagram that illustrates the overall process of managing risk and getting ready for risk-induced events.

FIG. 7 is a diagram that illustrates the critical role a risk manager fills while collecting program inputs, managing processes, and facilitating outcomes.

FIG. 8 is a block diagram that illustrates the utility of various embodiments described herein to help system users define, organize, track and manage program outcomes.

FIG. 9 is a table that illustrates the deconstruction/reconstruction of program outcomes and activities by examining them as program inputs, processes and outputs.

FIG. 10 is a computer screenshot of one embodiment used to track and manage risk management program outcomes and groups of outcomes.

FIG. 11 is a block flow diagram that illustrates the overall risk management program assessment process.

FIG. 12 is a computer screenshot of one embodiment used to organize and make accessible various risk management program assessment tools.

FIG. 13 is a computer-generated screenshot of a hazard/threat outcome properties page used to view and manage all information, including relationship dependencies with other outcomes and activities.

FIG. 14 is a block diagram that illustrates the overall process used to organize a risk management program.

FIG. 15 is a computer screenshot that illustrates a process and tool for prioritizing many risk management program outcomes.

FIG. 16 is a computer screenshot that illustrates process and tools for creating a risk management program strategic plan, inclusive of mission, vision, and principals or organizational value statements and strategic goals and objectives.

FIG. 17 is a computer screenshot that illustrates a process and tool for creating one or more risk management program work plans.

FIG. 18 is a computer screenshot that illustrates a process and tool for creating a chart of accounts used to fund specific projects.

FIG. 19 is a block diagram that illustrates the overall process used to manage the implementation of risk management program activities.

FIG. 20 is a computer screenshot that illustrates a preferred embodiment of an overall project management page.

FIG. 21 is a computer screenshot that illustrates a preferred embodiment of an individual project properties page.

FIG. 22 is a computer screenshot that illustrates how a system user can relate each project to one or project program outcomes.

FIG. 23 is a computer screenshot that illustrates a preferred embodiment of a “Task” management page.

FIG. 24 is a computer screenshot that illustrates how a system user manages stakeholder, stakeholder groups and, by extension, agency relationships.

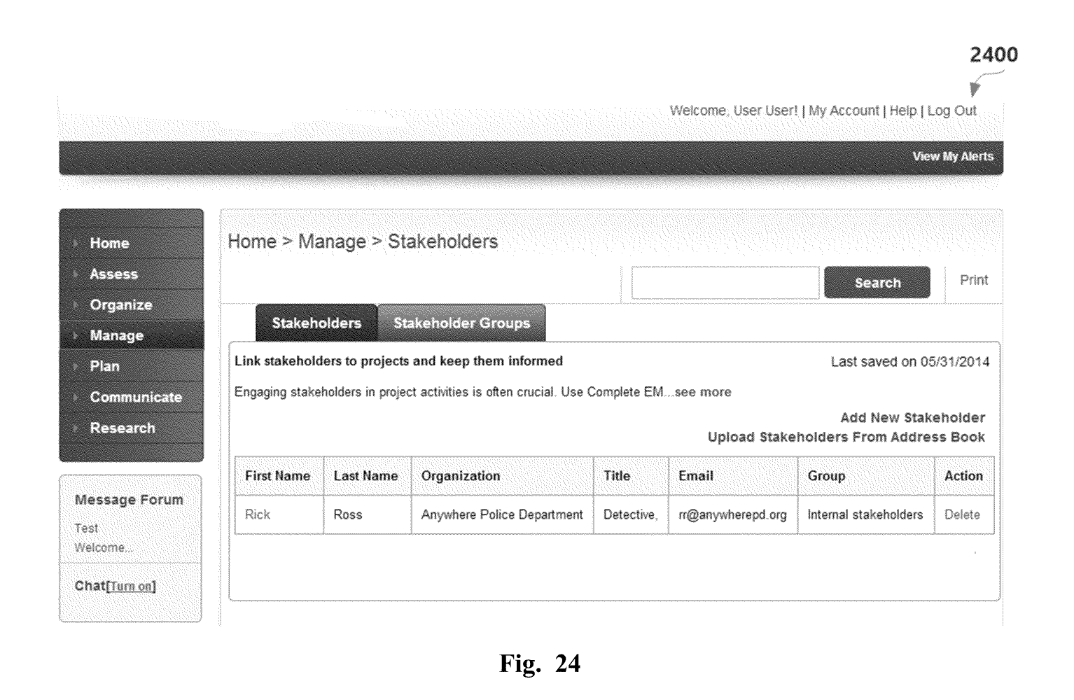

FIG. 25 is a computer screenshot that illustrates how a system user views and manages a comprehensive program calendar.

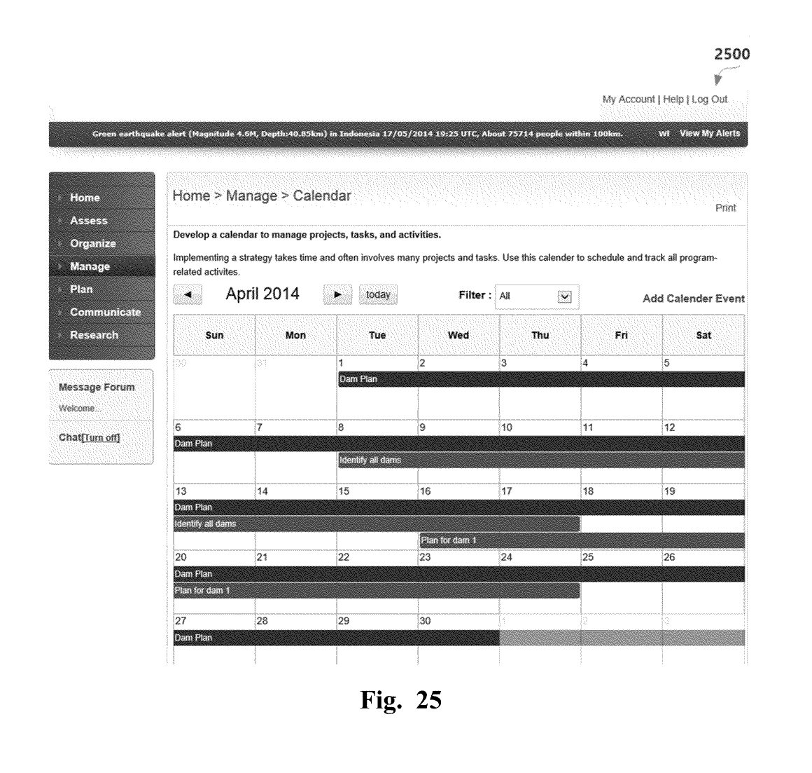

FIG. 26 is a computer screenshot that illustrates the GUI within a preferred embodiment used to log time on a task.

FIG. 27 is a computer network diagram that illustrates a preferred embodiment as an SaaS.

FIG. 28 is block diagram that illustrates software/hardware architecture of one embodiment.

FIG. 29 is a computer screenshot that illustrates the start of the SaaS user registration process.

FIG. 30 is a computer screenshot illustrating one embodiment in which several but not all examples of how assessment information can be used to report and management program readiness are provided.

FIG. 31 is a block diagram that illustrates the type of information necessary to effectively manage hazard/threat outcomes.

FIG. 32 is a computer screenshot of one embodiment to allow a system user to edit program performance metrics that apply to their program.

FIG. 33 is a computer screenshot that illustrates one preferred embodiment for defining and assessing important program relationships with internal and external organizations.

FIG. 34 is a computer screenshot that illustrates how a system user will identify individual program stakeholders and assign them to a new or existing relationship.

FIG. 35 is a computer screenshot that illustrates how system users can create custom groups of stakeholders

FIG. 36 is a computer screenshot that illustrates how system users quickly create a document from a list of document templates that have already been developed.

FIG. 37 is a computer screenshot that illustrates a communication menu by which a user can choose to send several types of documents, including invitations to participate in projects and program status reports.

FIG. 38 is a computer screenshot that illustrates how stakeholders and stakeholder groups are included quickly in program communications.

FIG. 39 is a computer screenshot that illustrates stakeholder access to any project-related note.

FIG. 40 is a block diagram that illustrates one embodiment that allows system users to easily create program documents by from templates.

FIG. 41 is a block diagram that illustrates one embodiment useful for easily monitoring and utilizing a vast number of information sources using only a simple, single-page GUI.

FIG. 42 is block diagram that illustrates a preferred embodiment to generate and share reports of program development.

FIG. 43 is a block diagram that illustrates how risk managers gain help for their program development efforts.

FIG. 44 is a computer-generated screenshot that illustrates how a system user assesses program element outcomes depending on the type of organization selected.

FIG. 45 is a computer-generated screenshot that illustrates how a system user assesses program capability outcomes depending on the type of organization selected.

FIG. 46 is a computer screenshot that illustrates the process used in one embodiment to create customized program performance metrics.

FIG. 47 is a computer screenshot that illustrates a system administrator's tool for defining, describing and assigning metrics to an organization type.

FIG. 48 is computer screenshot that illustrates how one embodiment relates any stakeholder to any project.

FIG. 49 is a computer screenshot that illustrates the utility of a comprehensive system help menu.

FIG. 50 is a computer screenshot that illustrates program development help text for each system page where users may need assistance with risk management program development.

FIG. 51 is a computer screenshot that illustrates the use of instructional videos for pages that involve major risk management concepts of activities.

FIG. 52 is a diagram that describes the whole of risk management in context.

FIG. 53 is a block diagram that illustrates the mitigation process.

FIG. 54 is a block diagram that illustrates the preparedness process.

FIG. 55 is a block diagram that illustrates the response process.

FIG. 56 is a block diagram that illustrates the recovery process.

FIG. 57 illustrates a diagrammatic representation of machine in the example form of a computer system or computing device within which a set of instructions when executed may cause the machine to perform any one or more of the methodologies described herein.

FIG. 58 is a block diagram that illustrates a general program management dashboard.

FIG. 59 is a block flow diagram that illustrates the process of determining program readiness.

FIG. 60 is a block flow diagram that illustrates the recovery process following a risk event.

### DETAILED DESCRIPTION

Various embodiments of systems and methods for enterprise risk management are described herein and numerous details are set forth in order to provide a thorough understanding of these embodiments. It will be evident, however, to one of ordinary skill in the art of risk management that such embodiments may be practiced without these specific details.

The practice of risk management can appear prohibitively complex, time-consuming and costly. The various embodiments described herein are designed to enable faster, less expensive and more effective risk management outcomes than traditional methods allow. A detailed description of these embodiments, therefore, requires an examination of risk management as an art and what makes this work challenging.

Many Outcomes to Manage—

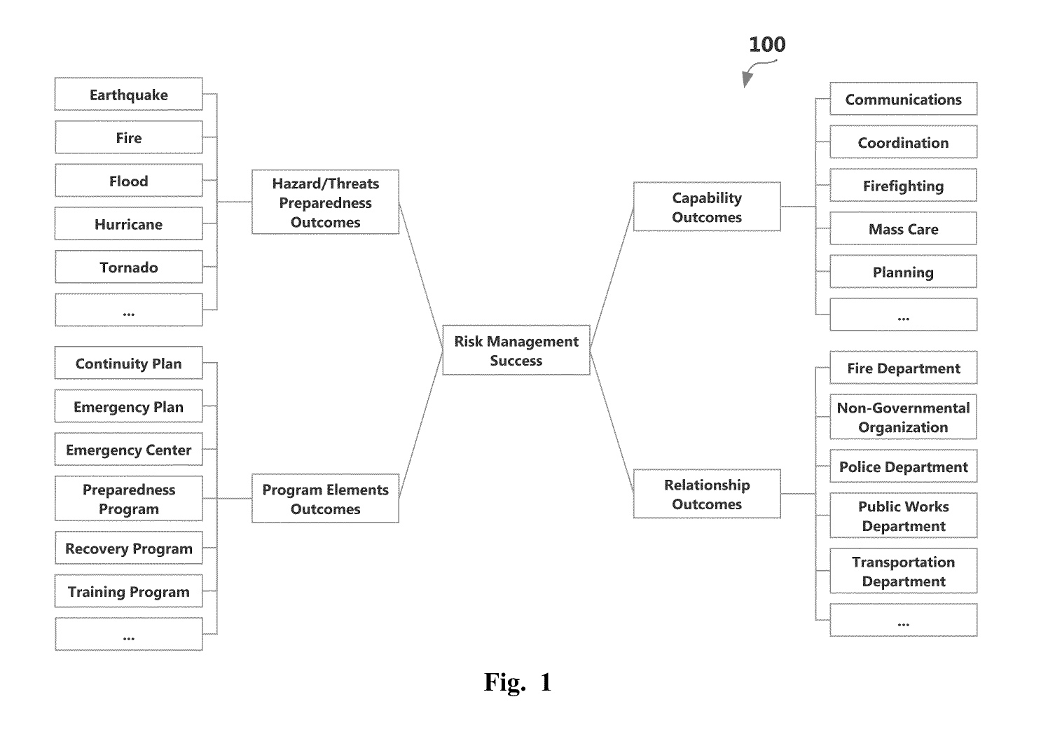

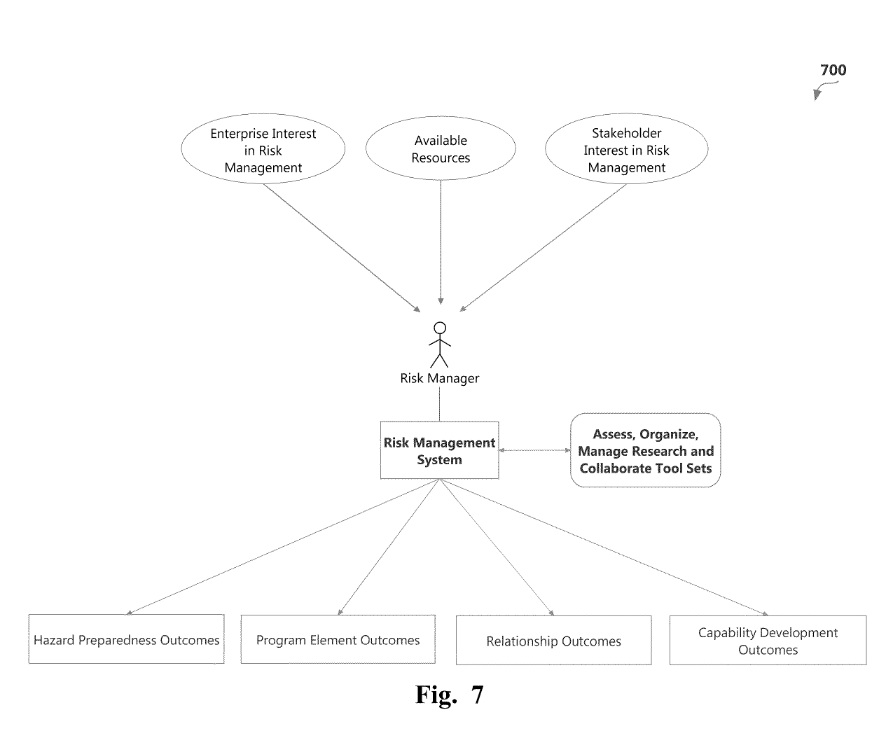

To be effective, risk managers must accomplish a large number of program outcomes. Part of this work involves identifying, assessing and preparing to address any number of hazards and threats. Each resulting outcome can be called a Hazard/Threat Preparedness Outcome. Risk managers must also establish certain program components like facilities, plans, procedures, and guides. These can be called Program Element Outcomes. Distinct from hazard/threat and element outcomes is the need to develop certain resources and capabilities to perform work (i.e., firefighting, emergency medical services, reconstituting information technology, sheltering, and threat interdiction). These can be called Capability Outcomes. Finally, maintaining a certain number of cooperative relationships with people, roles, and organizations is critical to effective risk management. These can be called Relationship Outcomes. FIG. 1 illustrates these four types of risk management program outcomes, specific examples of each outcome, and the relationship of each type of outcome to the success of a risk management program. It will be apparent to those of ordinary skill in the art of risk management and in view of the disclosure herein that the notion of deconstructing risk management program success as a collection of discrete outcomes is a novel concept. As such, the notion of having any number of required outcomes in the collection is also a novel concept. FIG. 7 illustrates, generally, how the various embodiments described herein support the identification, assessment, and achievement of risk management program outcomes.

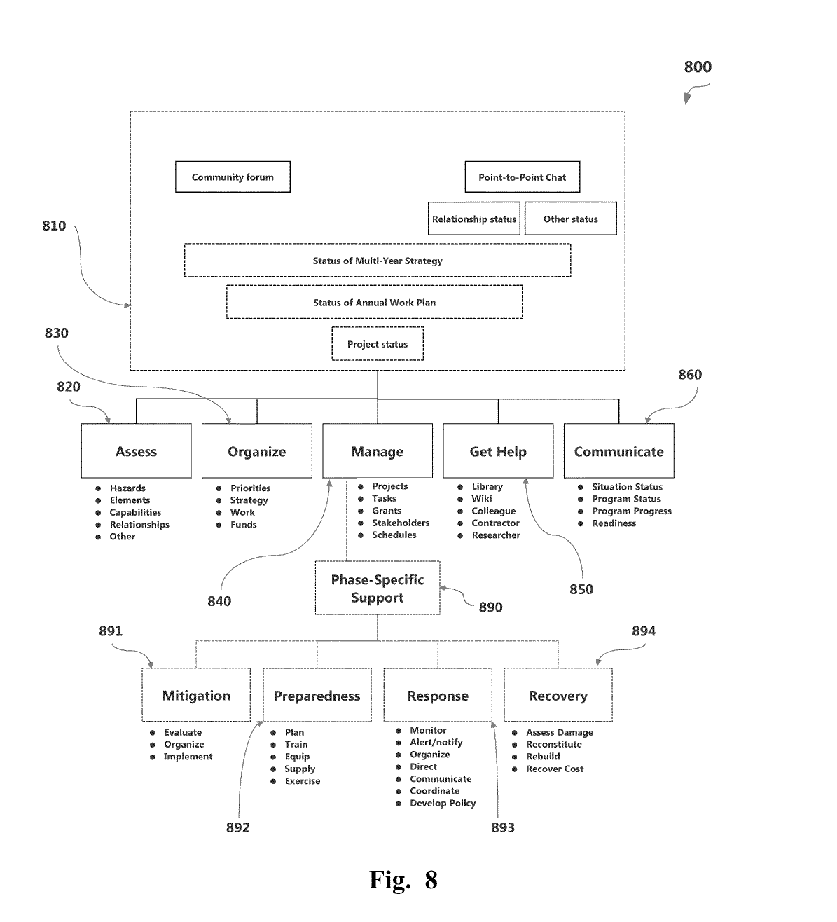

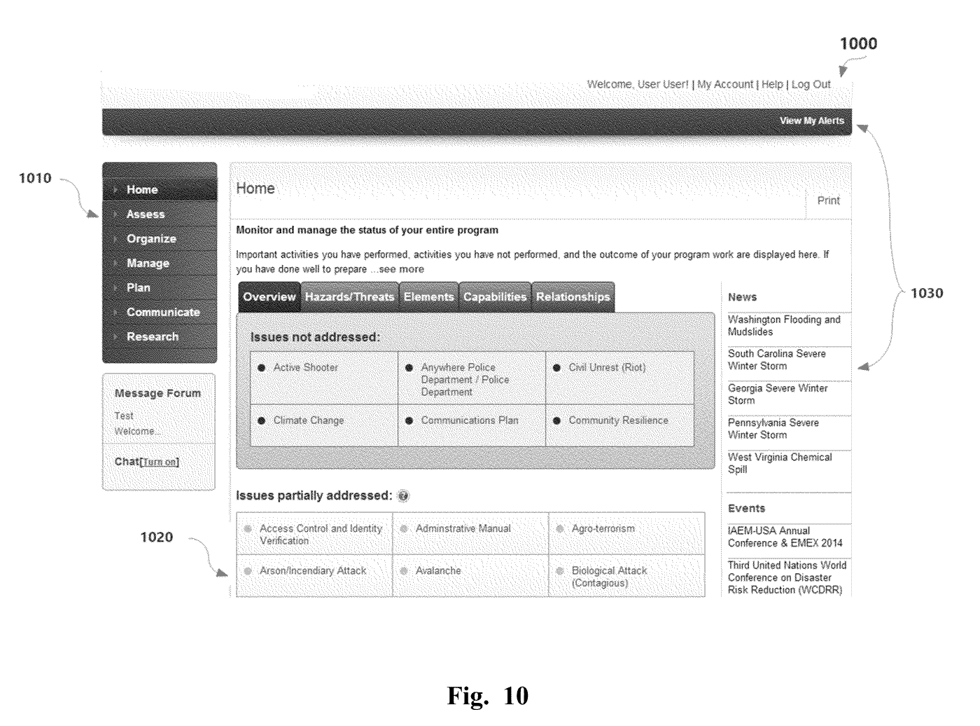

A typical risk manager is responsible for achieving approximately 100-200 different program outcomes. Identifying and tracking, let alone accomplishing, this volume and variety of work is extraordinarily difficult without the use of well-designed and enabling information technology, inclusive of an intuitive GUI and RDMS. FIG. 8 illustrates the scope of a comprehensive risk management system, inclusive of outcome management 810. FIG. 10 is a computer screenshot that illustrates the utility to track and manage program outcomes and groups of outcomes 1020. It will be apparent to those of ordinary skill in the art of risk management and in view of the disclosure herein that the notion of managing all risk management program outcomes from a simple GUI is a novel concept. As such, the display of any combination of outcomes represented with a simple GUI is also a novel concept.

Organizations Measure Success Differently—

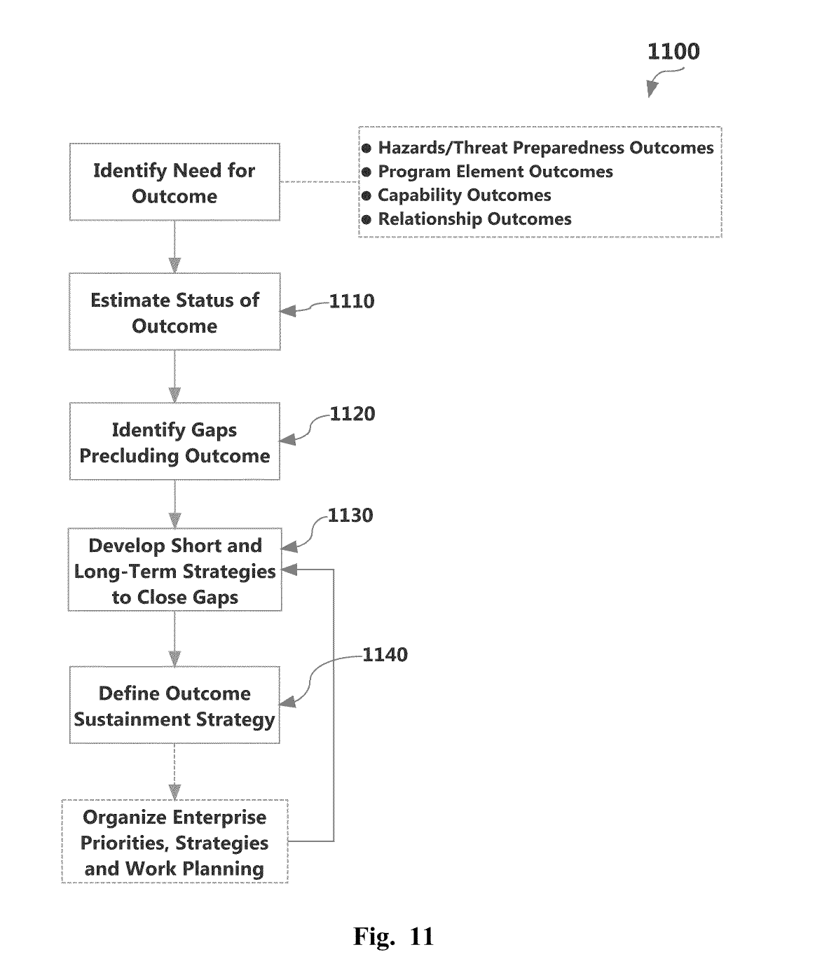

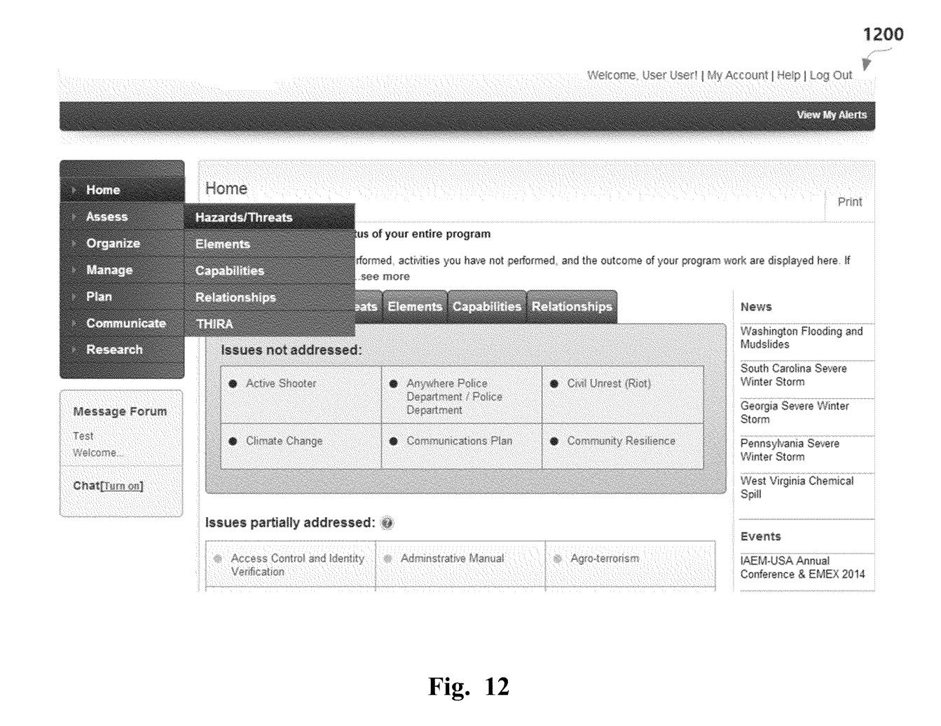

It is evident to one skilled in the art of risk management that program success is defined and determined, in large part, by the conduct of one or more program assessments. FIG. 11 is a block flow diagram that illustrates a risk management program assessment process. In one preferred embodiment, program assessments are conducted directly from a computer system dashboard using an “Assess” link on a common website navigation menu. Sub-menu items then link to outcome-specific assessment tools, depending on the type of risk management organization conducting an assessment and how that organization wants to assess its success. Once these parameters for an assessment are selected, a user then evaluates the status of each outcome 1110 while referring to outcome-specific metrics provided by the system. Users can then use these metrics to identify gaps 1120 that exist between the current status of each outcome and the requirements of final, desired outcomes. Users can then use the system to define both short-term and long-term strategies 1130 to achieve each outcome, reflecting a practical reality that program development often involves several alternatives: some that can be achieved quickly or easily; others that will require more time, resources or coordination. Because maintaining program outcomes once they are achieved is important, the system allows users to define such a strategy and the requirements of implementing this strategy when considering overall program development efforts. FIG. 12 is a computer screenshot that illustrates the operation of such a menu-driven collection of assessment tools. Under the expanded Assess sub-menu, FIG. 12 illustrates one part of a preferred embodiment in the form of a hazard/threat assessment tool. It will be apparent to one of ordinary skill in the art of risk management and in view of the disclosure herein that the notion of comprehensively assessing risk management program success by assessing various outcomes and groups of outcomes is a novel concept. As such, using any number and combination of these assessments to assess risk management program success is also a novel concept.

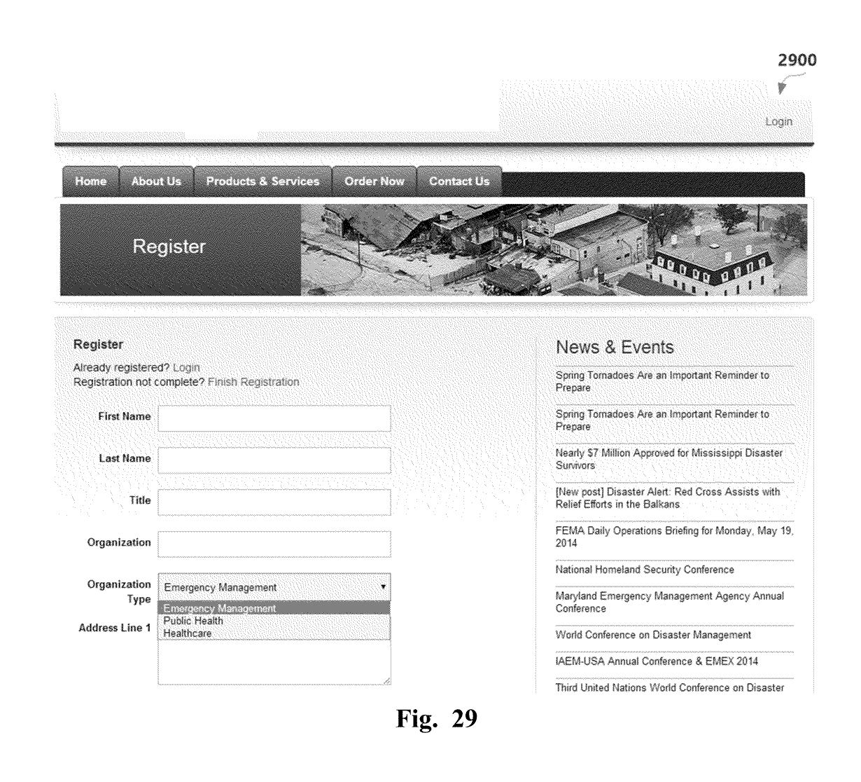

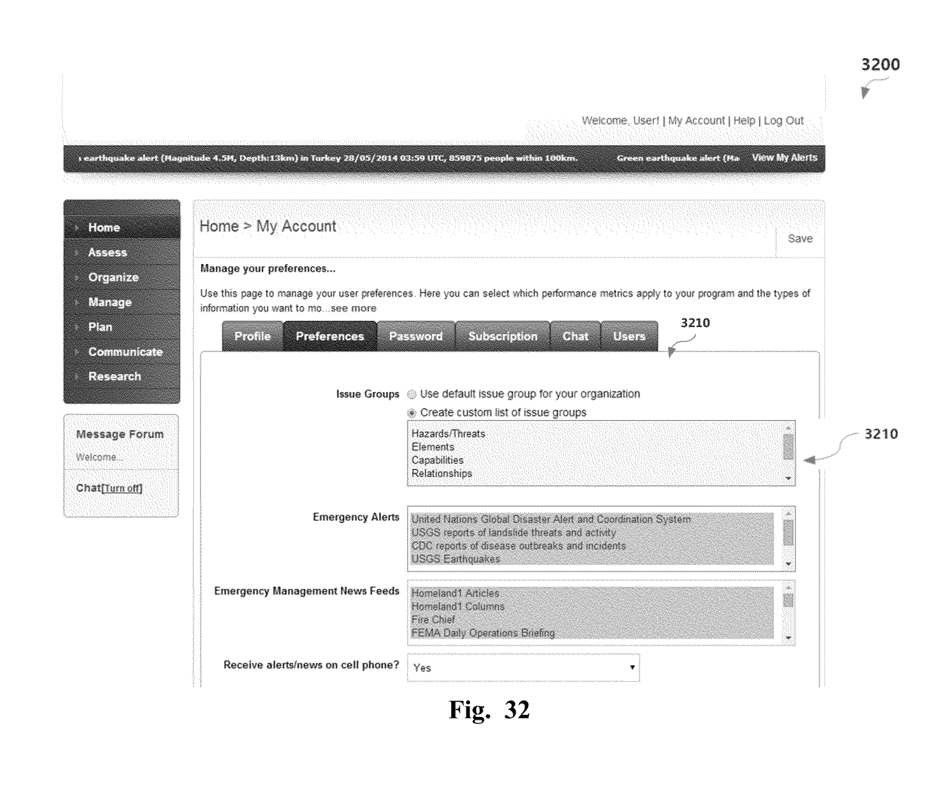

Different organizations, however, will define risk management program success differently. For example, some organizations will focus primarily on natural hazard risks like those posed by vulnerability to fire, flood, or avalanche. Other organizations will focus on risks related to regulatory or statutory non-compliance. It is important that each risk management program appropriately and adequately assesses risk and help to define program outcomes specific to a particular set of enterprise needs. FIG. 29 is a computer screenshot that illustrates one preferred embodiment to identify the type of system user which, in turn, is used to select a set of program assessment tools most appropriate to a user's organization. FIG. 32 is a computer screenshot that illustrates how such a user edits program performance metrics 3210 specific to the needs of their organization. It will be apparent to one of ordinary skill in the art of risk management and in view of the disclosure herein that the notion of having a discrete, custom, and computer-enabled set of program performance metrics for different types of organizations is novel.

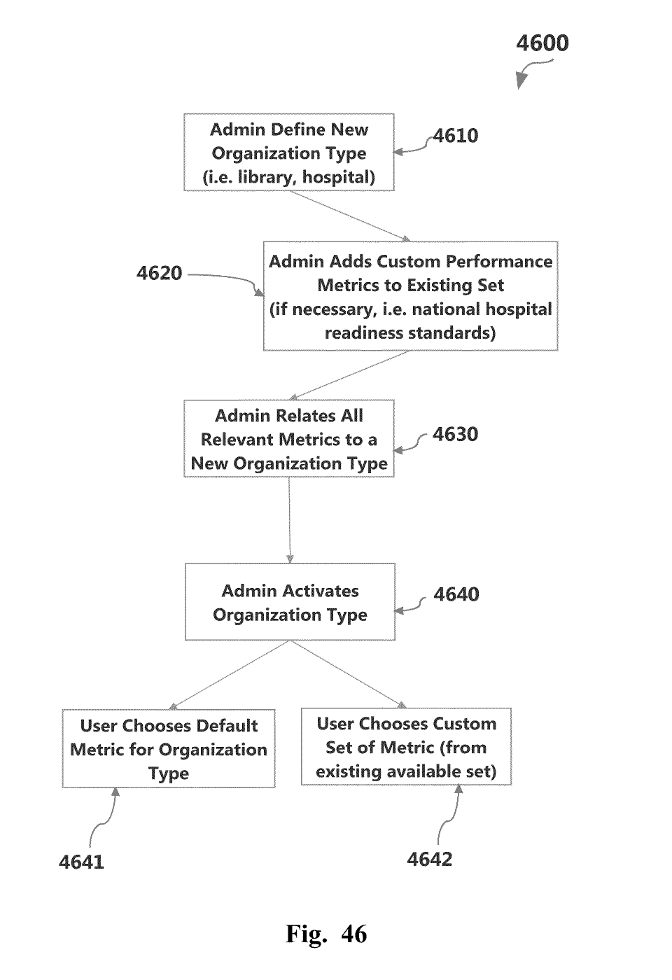

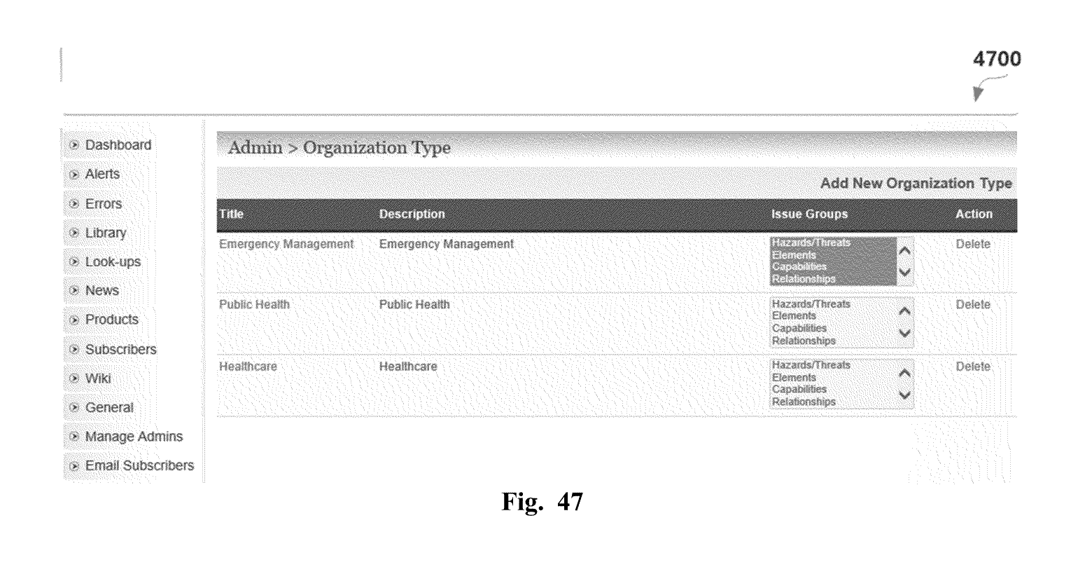

Making risk management program performance metrics available to a variety of organization types is, of course, important. Different metrics reflect the characteristics, interests and, ultimately, the path to program success for each organization. For example, consider a county public health agency and a financial services provider as two organizations required to manage enterprise risk. Both organizations will have hazards/threats, program elements, capabilities, and relationships to manage. A set of general hazard/threat and relationship assessment tools may be used to help them assess these outcomes, but the organizational or program differences between them may require a different set of program element or capability metrics to consider. The public health agency will want to have an isolation and quarantine plan developed in the case of a biological outbreak. The mutual fund manager will want to have multiple redundancies in computer networks and systems that connect them directly to customers, markets and buyers. FIG. 46 is a computer screenshot that illustrates the process used in one preferred embodiment to create customized program performance metrics. In this process, system administrators first define the organization type 4610. If this new organization type requires one or more additional metrics, new metrics are uploaded 4620 to the system to reside with the existing set of metrics. System administrators then determine a default set of metrics for the new organization type 4630. Based on all metrics available, system administrators then activate the new organization type and its suggested baseline metrics 4640. By performing this action, system users then able to quickly select a default set of metrics 4641 for their organization or choose a custom stet of metrics 4642. FIG. 47 is a computer screenshot that illustrates a system administrator's tool for defining, describing and assigning metrics to an organization type. It will be apparent to those of ordinary skill in the art of risk management and in view of the disclosure herein that the notion of automating and customizing the selection of risk management program performance metrics is a novel concept.

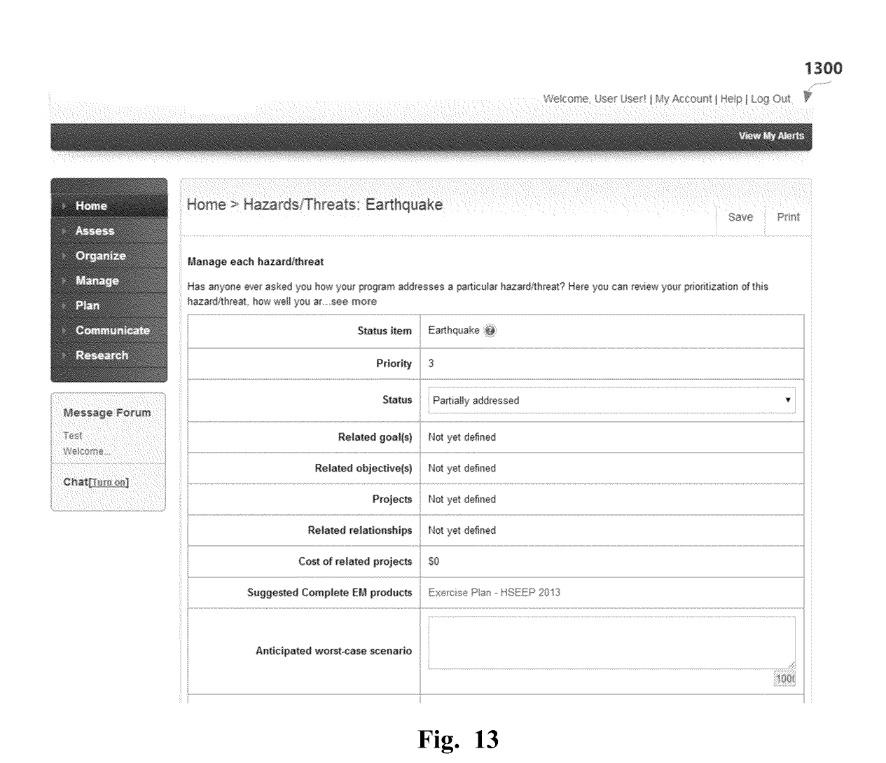

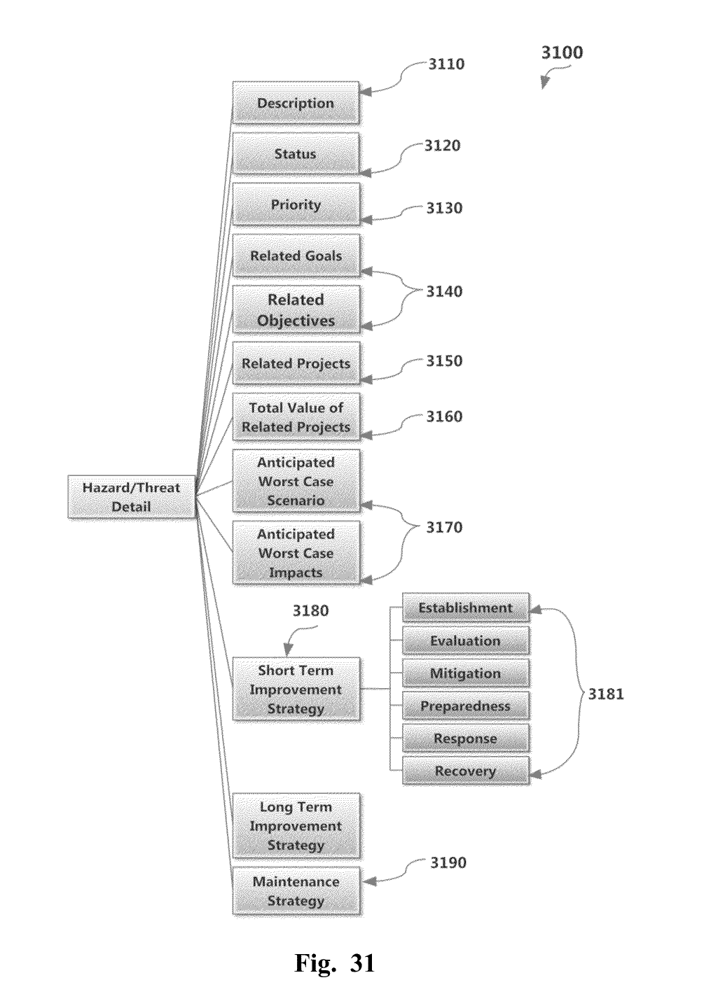

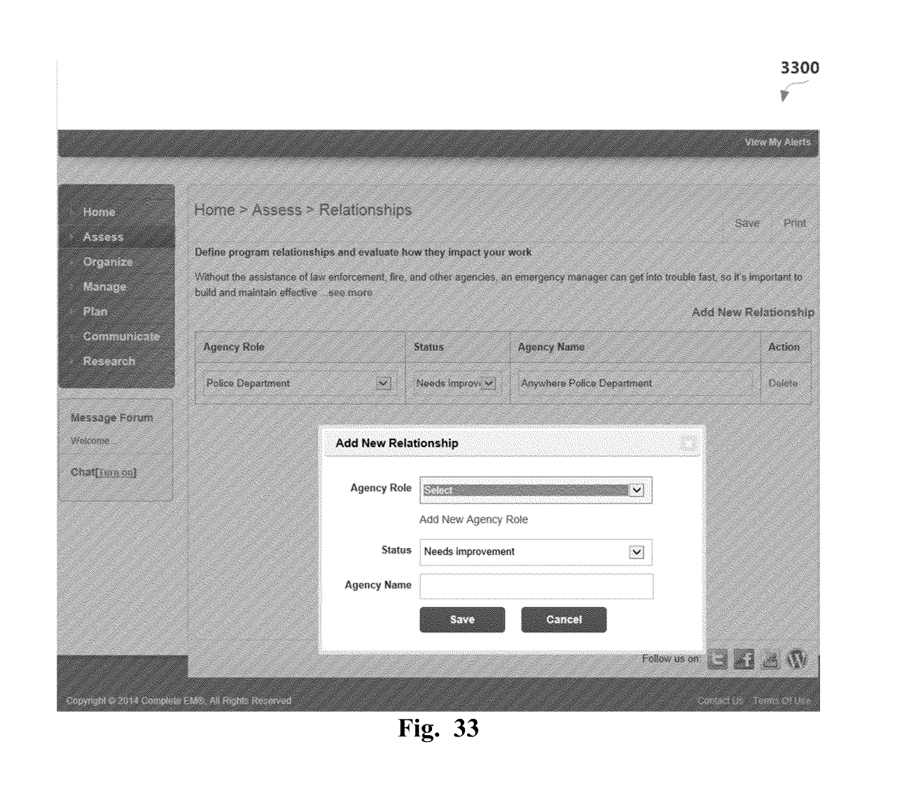

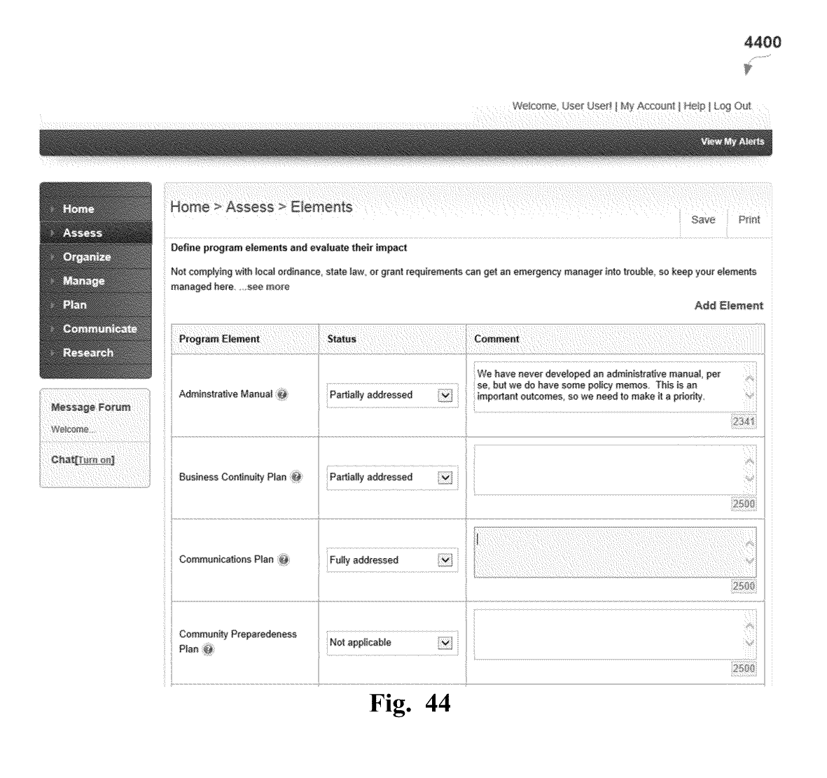

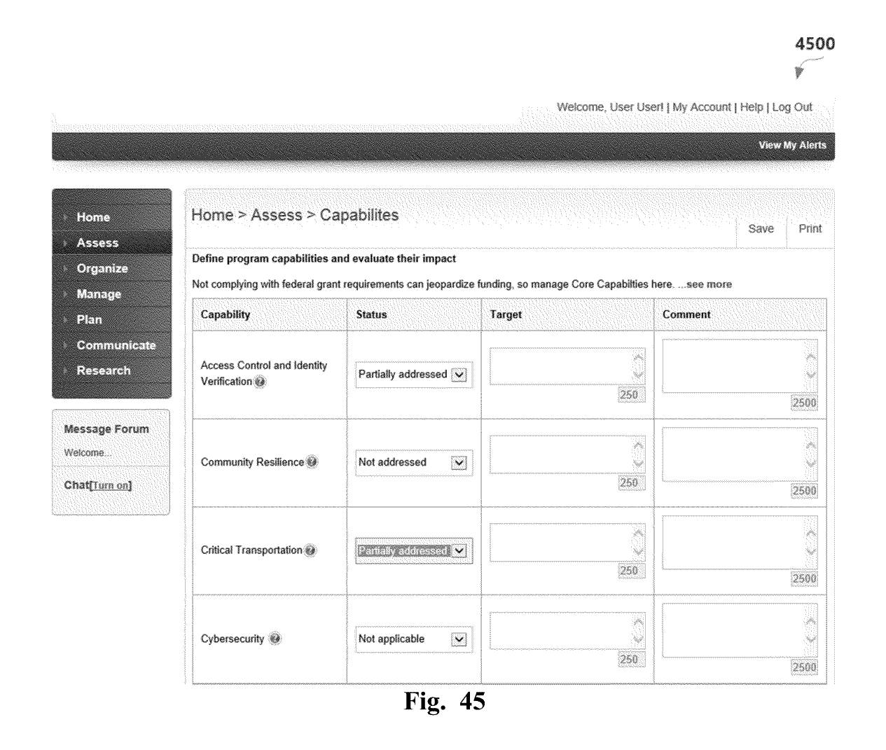

Once program outcomes are identified using metrics and assessments, it is important for risk managers to place them into context and to consider program development needs that involve a broad spectrum of activities and interdependencies. FIG. 31 is a block diagram that illustrates the type of information necessary to define and manage risk management outcomes, in this case, for a hazard/threat-related outcome. The information needed to do so includes: a description of the outcome 3110; the status of the outcome (gathered from the assessment process) 3120; the program priority for achieving the outcome 3130; how the outcome relates to program strategy (goals and objectives) 3140; a list of projects that help accomplish the outcome 3150; the value of supporting projects 3160; characteristic consequences of not achieving the outcome 3170; outcome improvement strategies 3180 in sufficient detail to help determine program readiness 3181; and an outcome maintenance strategy 3190. FIG. 13 is a computer-generated screenshot of a preferred embodiment hazard/threat outcome properties page used to view and manage this information, including relationship dependencies with other outcomes and activities. All risk management programs will have several outcomes to manage from such a page. FIG. 44 is a computer-generated screenshot of a program element assessment page within a preferred embodiment used to begin defining program element outcomes. In this example, a summary of international emergency management program standards (relating to program elements) are used to create a set of metrics. FIG. 45 is a computer-generated screenshot of a capability assessment page within a preferred embodiment used to begin defining program capability outcomes. In this example, a summary of U.S. Homeland Security Core Capabilities are listed and made available for assessment. FIG. 33 is a computer-generated screenshot that illustrates a method within a preferred embodiment for assessing important program relationships with internal and external organizations. It allows a system user to identify critical agency relationships (i.e. police department, insurance company, production materiel supplier), name the agency that represents this relationship, and assess the quality of this relationship as it pertains to the risk management program. It will be apparent to those of ordinary skill in the art of risk management and in view of the disclosure herein that the notion of deconstructing hazard/threat, element, capability and relationship outcomes as a means to define, assess, track, relate and manage risk management program outcomes is a novel concept.

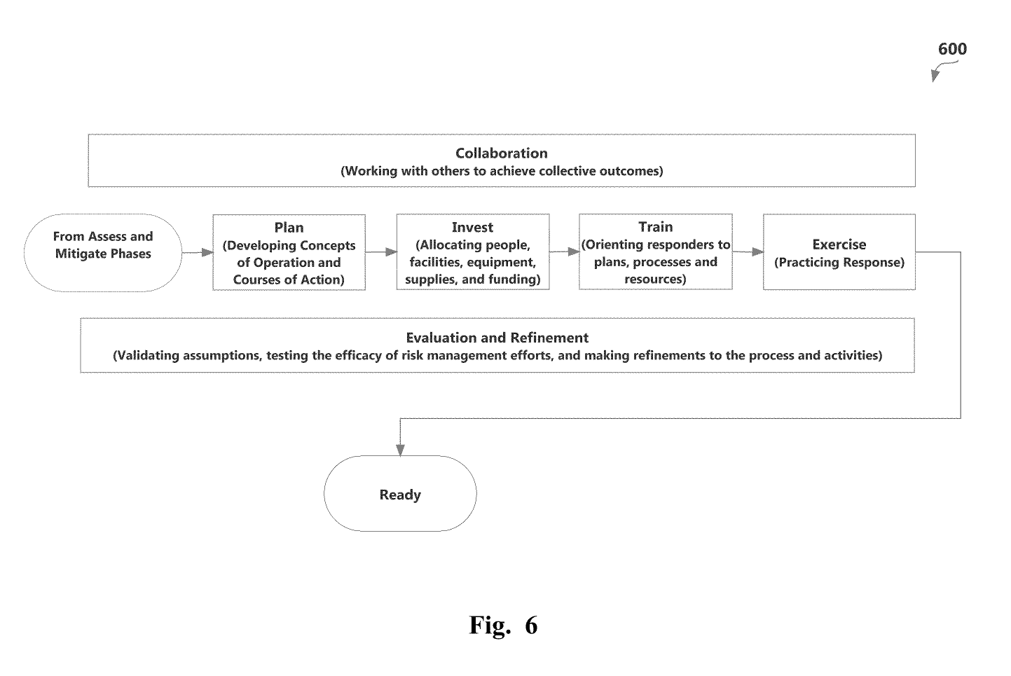

One of the more important challenges inherent to risk management program development is the lack of objective metrics to measure readiness. Several international risk management program standards exist (i.e., EMAP, NFPA® 1600) but their purpose is to help a program determine if certain elements of their program are in-place, not to determine if their program is ready for a risk-induced event. For example, these standards may indicate a need to develop one or more plans, but does not prescribe how often those plans should be reviewed, used to train stakeholders, or practiced in an exercise. The latter activities are more instrumental to determining program readiness and, therefore, program success. An evaluation of capability is also not effective for determining program readiness. For example, a risk management organization may have acquired a certain specialized capability years ago but not maintained or tested it in some time. A capability assessment might show that such a capability does indeed exist, but fail to show a lack of readiness when the capability has not been maintained. Considered separately, neither hazard/threat, program element, capabilities nor relationships alone determine program readiness. Doing so requires considering all of these program issues or outcomes in total. FIG. 6 is a block flow diagram that illustrates the process of becoming ready. The process begins with recognizing risk and then analysing risk. From this analysis, one or more plans can be developed after considering a variety of scenarios, degrees of impact, and alternatives for eliminating, reducing, responding to risk. Indeed, one or more plans may be developed to address several risk management phases. Investments are then made to achieve readiness as the necessary people are trained and exercised. Throughout the entire process of becoming ready, a risk management program engages in regular collaboration with program stakeholders and continuous program evaluation and improvement. It will be apparent to those of ordinary skill in the art of risk management and in view of the disclosure herein that the notion of risk management readiness as a product of accomplishing seven incremental steps and two ongoing support processes with respect to specific program outcomes, is a novel concept.

Complex Interdependencies Exist Between Outcomes and Activities—

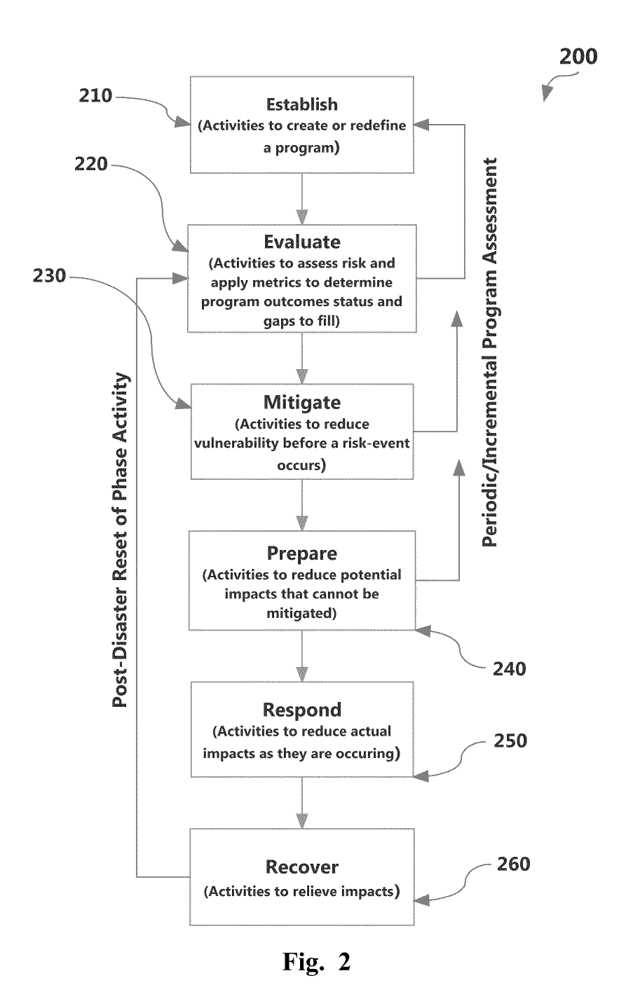

It is evident to one skilled in the art of risk management that such work is performed in phases. Although no consensus defines the exact number or name of phases, defining this work is necessary to ensure that adequate attention is given to, and sufficient outcomes are accomplished for, each type of risk management activity. Further describing one preferred embodiment, FIG. 2 illustrates the following six phases of risk management activity:
a. Establishment 210—Activity to define and constitute a risk management program;
b. Evaluation 220—Activity to identify and define program requirements, readiness and shortcomings;
c. Mitigation 230—Activity designed to identify risk and reduce enterprise vulnerability before it can generate negative impacts for an enterprise;
d. Preparedness 240—Activity designed to prepare for impacts that cannot be mitigated;
e. Response 250—Activity designed to address imminent and actual impacts; and
f. Recovery 260—Activity designed to relieve or remove impacts from an event that has occurred.
   It will be apparent to those of ordinary skill in the art of risk management and in view of the disclosure herein that the notion of six discrete phases of risk management activity is a novel concept.

FIG. 2 is a block flow diagram that also illustrates risk management activity (phases) as linear, iterative and cyclical in nature. Risk management phases can be considered linear because some phases should precede others. For example, a risk manager should attempt to reduce vulnerability before preparing to respond to a risk-induced event like an emergency. Not performing earlier work like mitigating vulnerability may expose a program to unnecessary risk. Thus, mitigation should be considered a prerequisite phase to preparedness. Risk management phases can also be considered iterative as it common for risk managers to return to a preceding phase to perform more work if unnecessary or extraordinary challenges are encountered in a subsequent phase. For example, while contemplating a complex response plan to evacuate a community that is subject to flooding, a risk manager may return to the mitigation phase to reconsider the installation of better flood protection or advance warning measures to reduce the need for more complex evacuation planning later. Phases can also be considered cyclical, insofar as risk management programs necessarily reset activity following a risk-induced event like an emergency. For example, hazard-related risks can be anticipated, partially mitigated, prepared for, responded to and then recovered from. A risk manager's subsequent responsibility is to then prepare for the next instance of a risk-induced event by re-examining the entire process of risk management and revisiting each phase. Thus, it may be said that a risk management program resets or cycles back to the Establishment 210 or Evaluation 220 phase of program management activity after a risk-induced event occurs, so that a program may sufficiently prepare for the next event. It will be apparent to those of ordinary skill in the art of risk management and in view of the disclosure herein that the notion of emergency management phases occurring as a set of linear, iterative and cyclical processes is a novel concept.

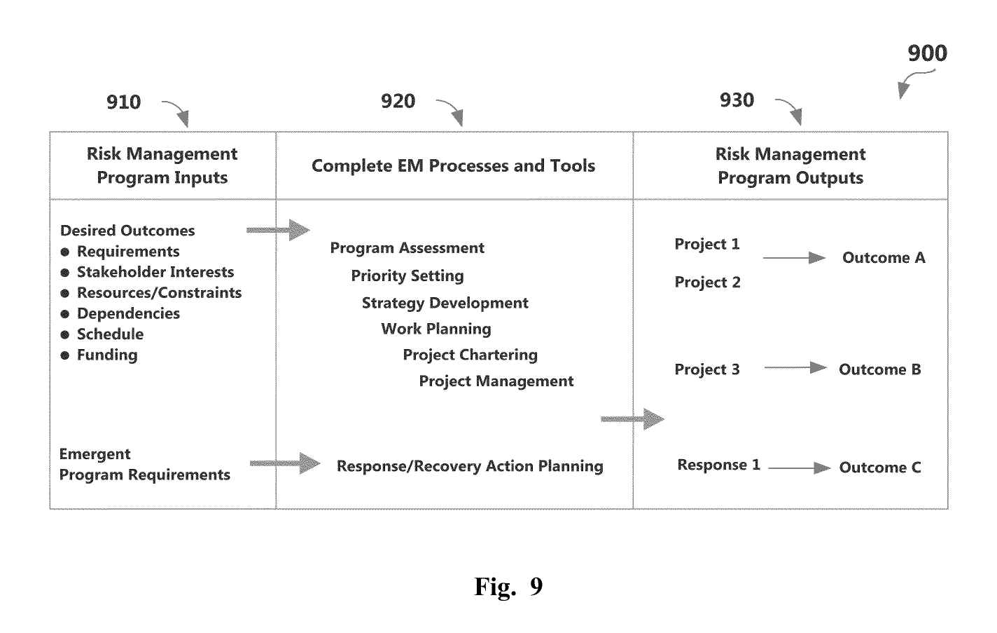

One preferred embodiment relates program outcomes to phase activity by allowing a user to define, prioritize, organize, resource, fund, and schedule projects. By systematically deconstructing seemingly disparate outcomes and phase activity and then reconstructing them into related projects, a user is able to create and manage relationships among and between outcomes and phase activity, especially critical program development interdependencies. FIG. 9 is a table that illustrates the deconstruction/reconstruction of program outcomes and activities by examining them as program inputs, processes and outputs. The first column of the table 910 lists administrative requirements, stakeholder interests, resources, constraints, dependencies, schedules and funding, as well as emergent program requirements (i.e. the need to respond to an emergency event like an earthquake). Collectively, risk managers view these as program inputs. The second column of the table 920 illustrates a collection of processes and tools that allow risk managers to transform program inputs into useful program outputs. These processes and tools include applying program metrics to assess a program, establishing program development priorities, developing a multi-year program improvement strategy, creating regular work plans, chartering projects, and accomplishing project management. The third column of the table illustrates program outputs 930—projects that, when completed, contribute to the systematic achievement of desired program outcomes. It will be apparent to those of ordinary skill in the art of risk management and in view of the disclosure herein that a system for cataloguing all risk management inputs and outputs, and managing, by way of computerized system, the discrete processes inherent in this transformation of program inputs into outcomes is novel.

FIG. 7 illustrates the general but critical facilitation role a risk manager fills in a risk management program. FIG. 9 illustrates this role in more detail, by describing risk management program inputs, processes and tools, and outputs. It will be apparent to those of ordinary skill in the art of risk management that processes and tools 920 can be further divided into two groups: a) organizational processes and tools; and b) operational processes and tools. Organizational processes and tools are used to better define the scope, order, and schedule of program work and focus program efforts to prioritize and coordinate outcomes. They are described in the next section. Operational processes and tools help risk managers effectively complete work that has already been organized well. These processes are described in a later section entitled: Disproportionately Small Level of Control and Influence. It will be apparent to those of ordinary skill in the art of risk management and in view of the disclosure herein that the notion of separate organizational and operational tools and processes to accomplish risk management program outcomes is novel.

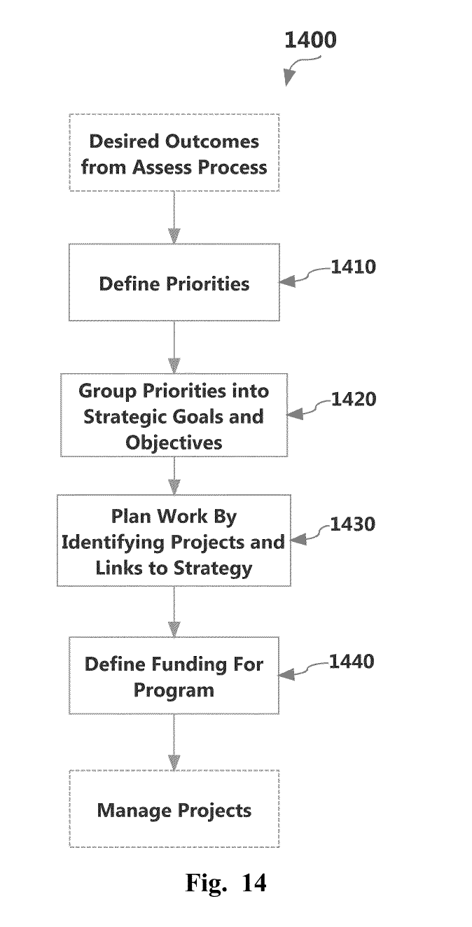

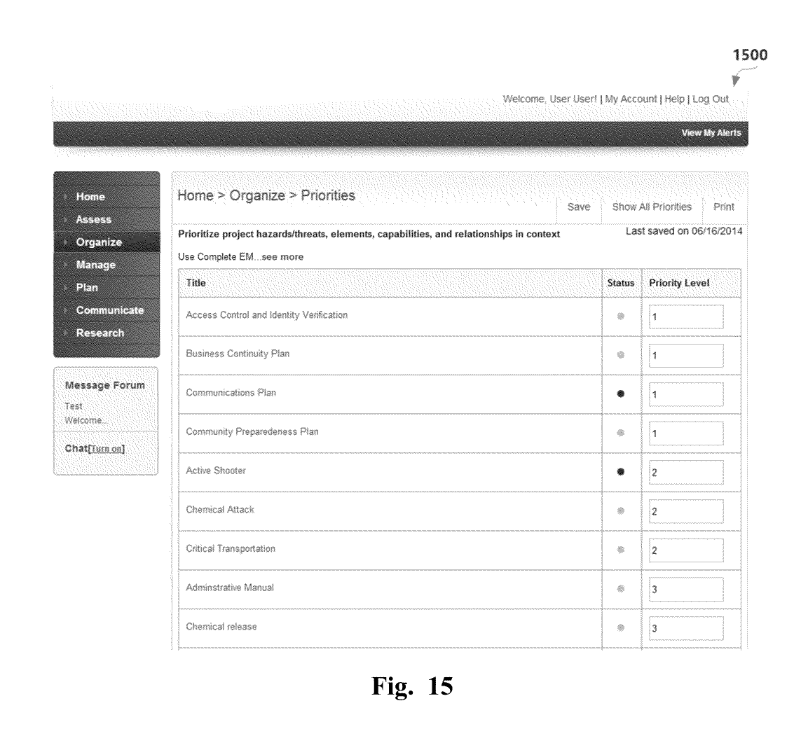

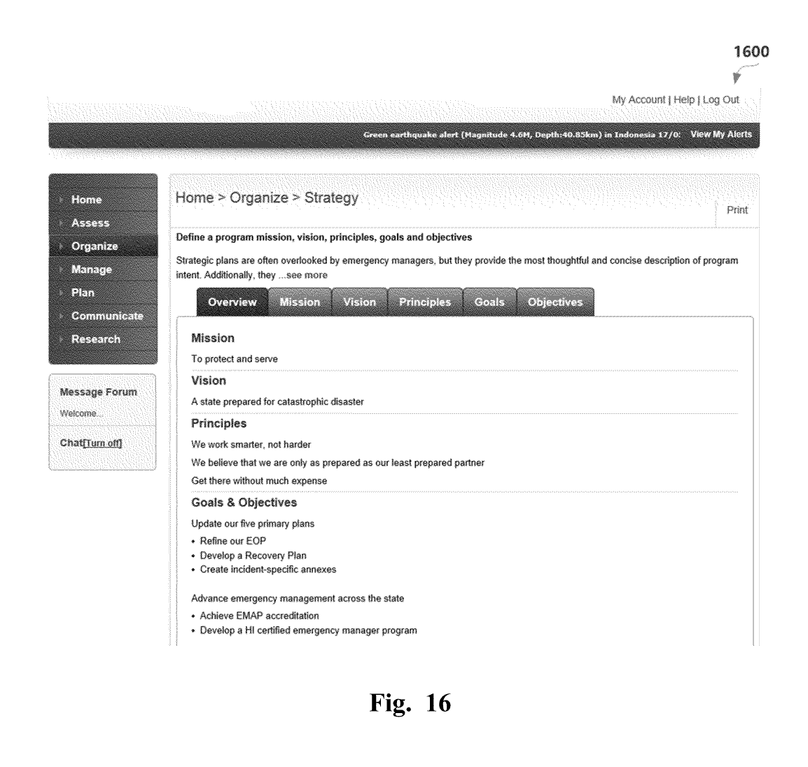

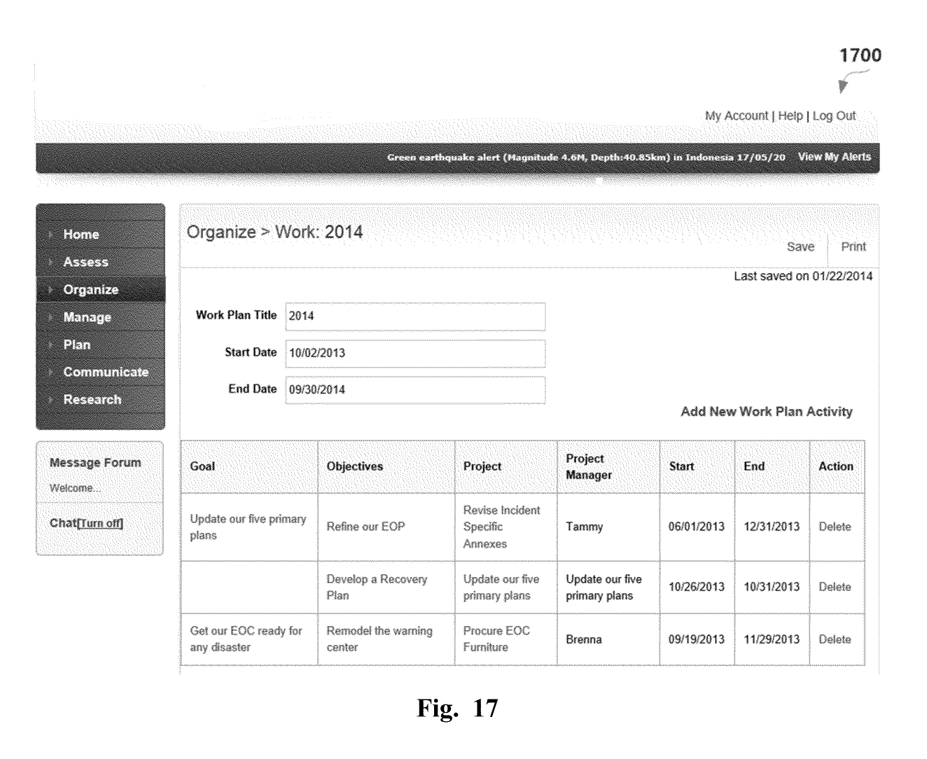

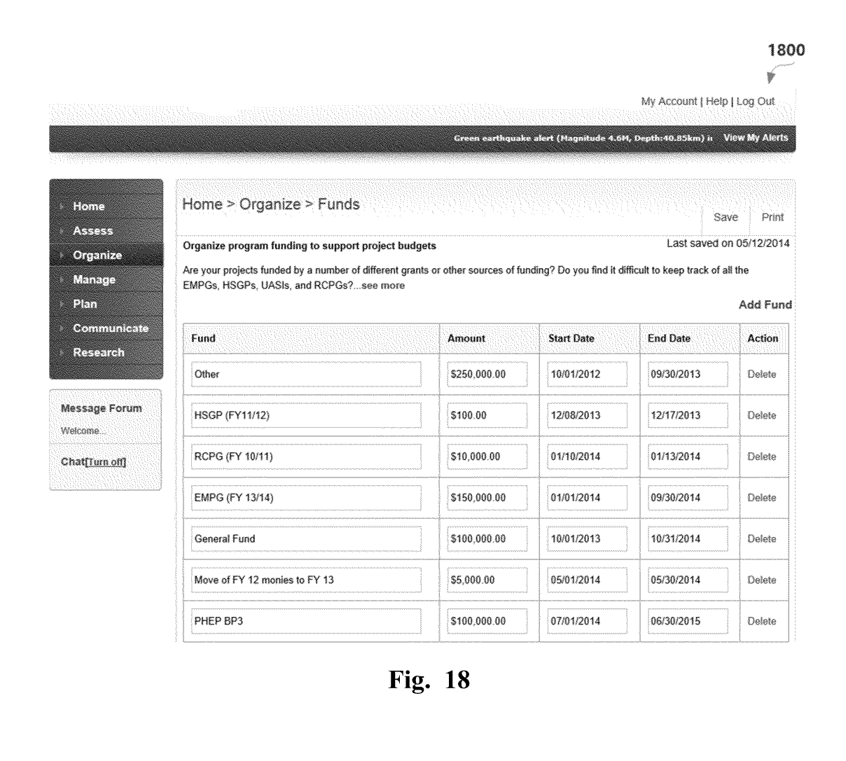

FIG. 14 is a block diagram that illustrates the overall process used to organize a program. A preferred embodiment allows a system user to prioritize 1410 the order of the outcomes a program wants to accomplish. FIG. 15 is a computer screenshot that provides an example of this highest-level organizational process and tool in a preferred embodiment. Using a list of prioritized program outcomes, a user can then create a strategic plan 1420, inclusive of a mission, vision, and principal or organizational value statements, as well as articulate program outputs as a set of strategic goals and objectives. FIG. 16 is a computer screenshot that illustrates one preferred embodiment of a set of strategy development organizational processes and tools. System users create mission statements and visions for their risk management program. They also articulate program values or principles before creating strategic goals and objectives for their program. By developing a strategy in such a way, and particularly by creating program goals and objectives, users are able to easily create groups for related outcomes and activities. Using prioritized outcomes grouped as goals and objectives, a system user is then able to develop a program work plan 1430. Users can name these work plans, schedule successive work plans, and then use them to introduce projects that will produce the desired program outcomes. FIG. 17 is a computer screenshot of a preferred embodiment that illustrates a risk management work plan view and particularly how projects are related to program goals and objectives. FIG. 18 is another computer screenshot of a preferred embodiment that illustrates how a system user can organize a chart of accounts 1440 to fund specific program activities. It will be apparent to those of ordinary skill in the art of risk management and in view of the disclosure herein that the notion of priority setting, strategizing, work planning and fund management processes and tools, presented as a computerized and integrated system is a novel concept.

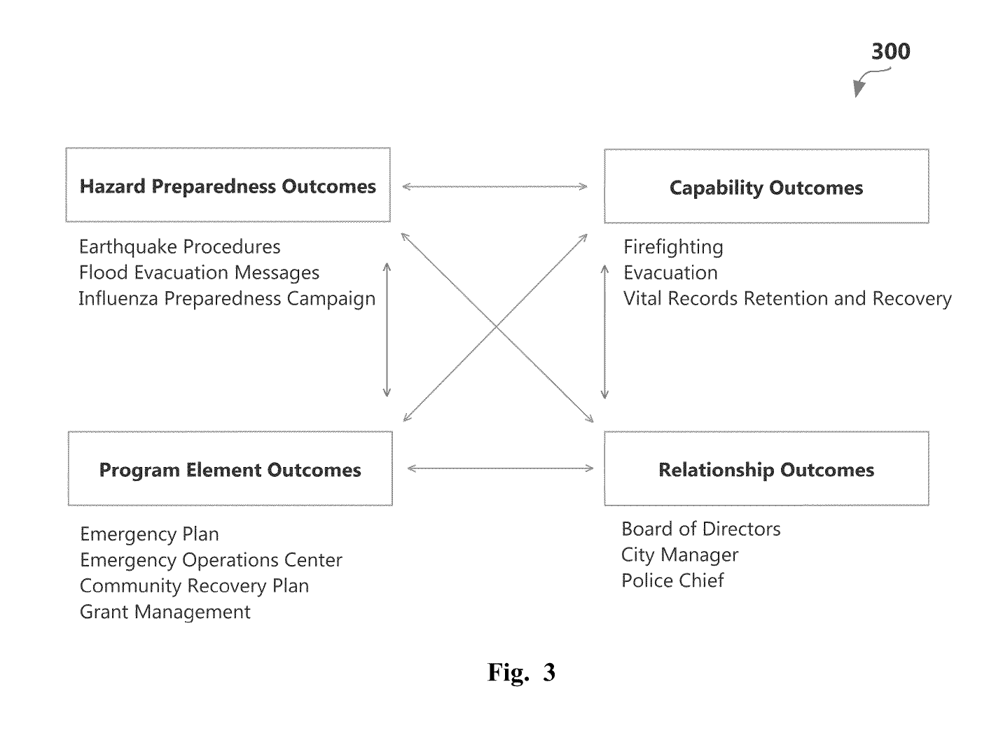

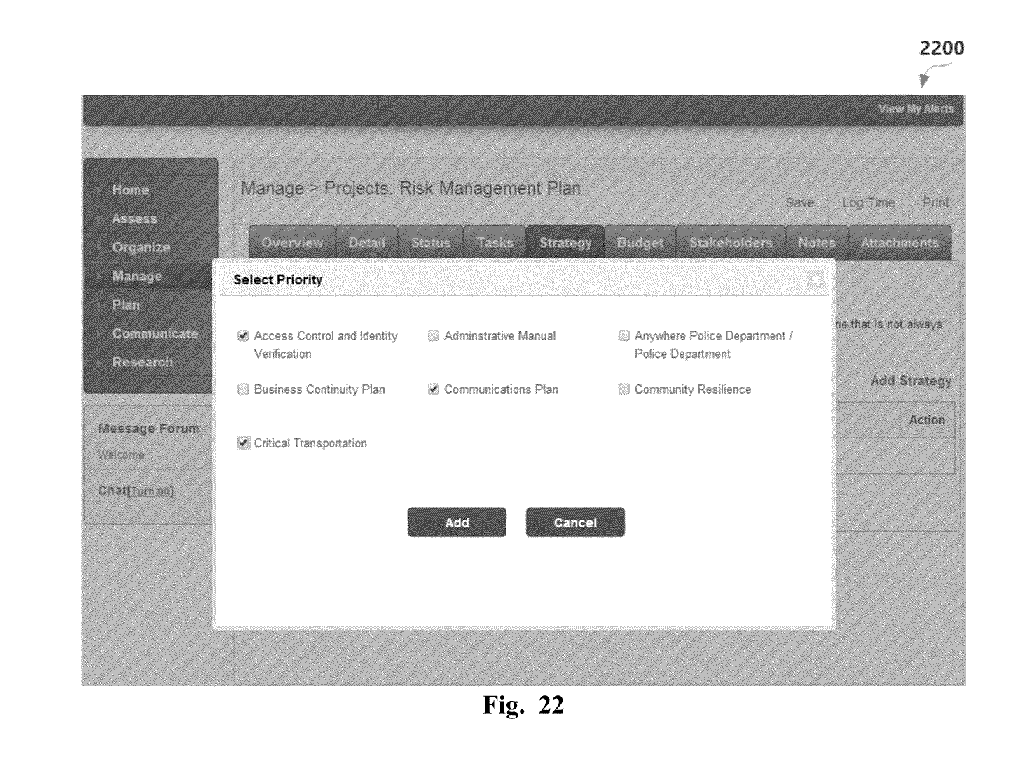

Once desired program outcomes have been assessed and organized into priorities, strategy, work plans, funding allocations and potential projects, the task of relating each organized program activity (a project) to a desired outcome becomes simple with one preferred embodiment. Doing so becomes beneficial because many outcomes share interdependencies. Work on one project typically affects more than one program outcome, so a many-to-many type of relationship can exist between projects and outcomes. FIG. 3 is a block diagram that illustrates the high degree of interdependency that can exist between risk management outcomes. It provides an example of how efforts to prepare for an earthquake can greatly depend on the existence of an enterprise emergency plan (an outcome), the capability to evacuate a facility (another outcome), and the status of various working relationships within an enterprise (several other outcomes). For the purpose of defining and managing these interdependencies one preferred embodiment relates every project to one or more outcomes. FIG. 22 is a computer screenshot that illustrates how a system user can relate each project to one or more program outcomes. This preferred embodiment also allows a user, for example, to track how many program outcomes a project will accomplish, how a project will help, in whole or in part, to accomplish a work plan or strategic plan, and to keep track of all project funds expended on a particular hazard, priority, goal, objective, or activity. Projects, in effect, provide a nexus or key for relating all program attributes, inputs, interests, resources, processes, activities, and outputs. It will be apparent to those of ordinary skill in the art of risk management and in view of the disclosure herein that the notion of defining and tracking relationships between a multitude of program attributes and factors is a novel concept.

Numerous Risk Management Stakeholders—

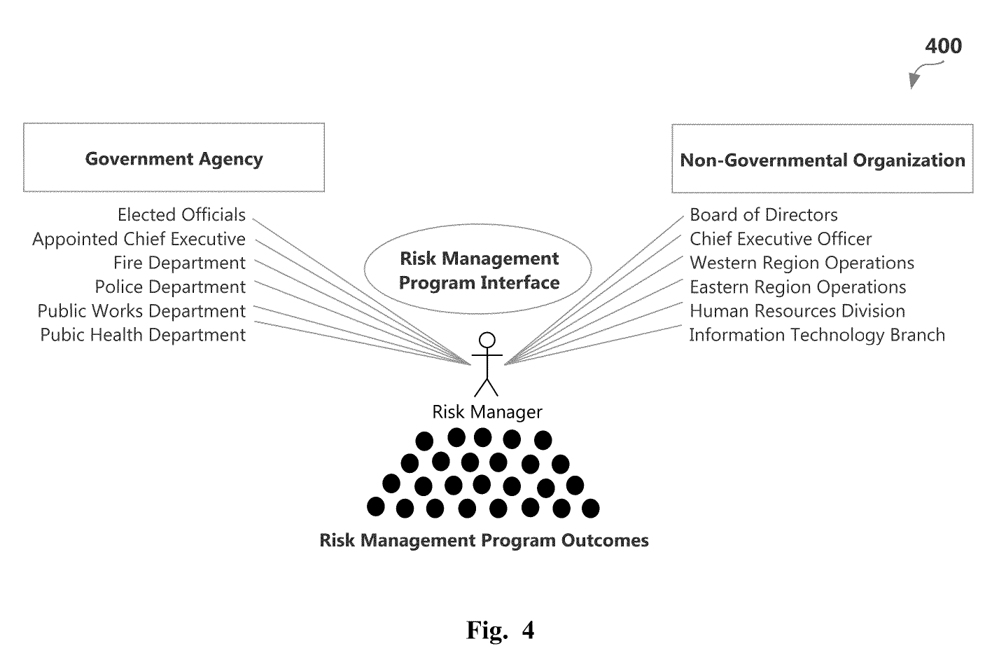

Many different people, resources and activities can contribute to a functioning risk management program. A single risk manager may be expected to coordinate the collective effort of hundreds or thousands of people. For example, attorneys may lead one unit; manufacturing technicians, police officers and civil engineers may lead others. It is the responsibility of risk managers to engage each unit effectively for the purpose of integrating them into a collective enterprise risk management program. FIG. 4 is a diagram that illustrates the critical role a risk manager fills in transforming many different stakeholder interests into shared and useful program outcomes. It is evident to one skilled in the art that risk managers must engage and relate well with many program stakeholders of various types, including those with different skills, experience, education, availability, etc. Specifically and in this regard, risk managers need to:
a. Manage distinct, critical program relationships with internal and external agencies;
b. Identify, engage, and coordinate the involvement of one or more stakeholders for each critical agency relationship;
c. Communicate effectively with program stakeholders; and
d. Work with maximum efficiency and effect because the ratio of risk management staff to stakeholders may be 1:50 or less.
   Embodied methods for overcoming these program challenges are described below.

Maintaining effective relationships with internal and external organizations is a high priority for risk managers. Without these relationships, assessments, planning, training, response, and recovery may be unobtainable. Thus it is critical that risk managers carefully identify, define and manage each organizational relationship. FIG. 33 is a computer screenshot that illustrates one preferred embodiment for defining and assessing important program relationships. It allows a system user to identify a critical agency relationship (i.e., police department), name the agency that represents this relationship, and assess the quality of this relationship as it pertains to the risk management program. These relationships are then managed as any other program outcome (illustrated previously in FIG. 10 and FIG. 8) depending on their potential contribution to program success. It will be apparent to those of ordinary skill in the art of risk management and in view of the disclosure herein that the notion of identifying, defining, and managing key agency relationships, by means of systematic and computerized processes, as an element of risk management program success is a novel concept.

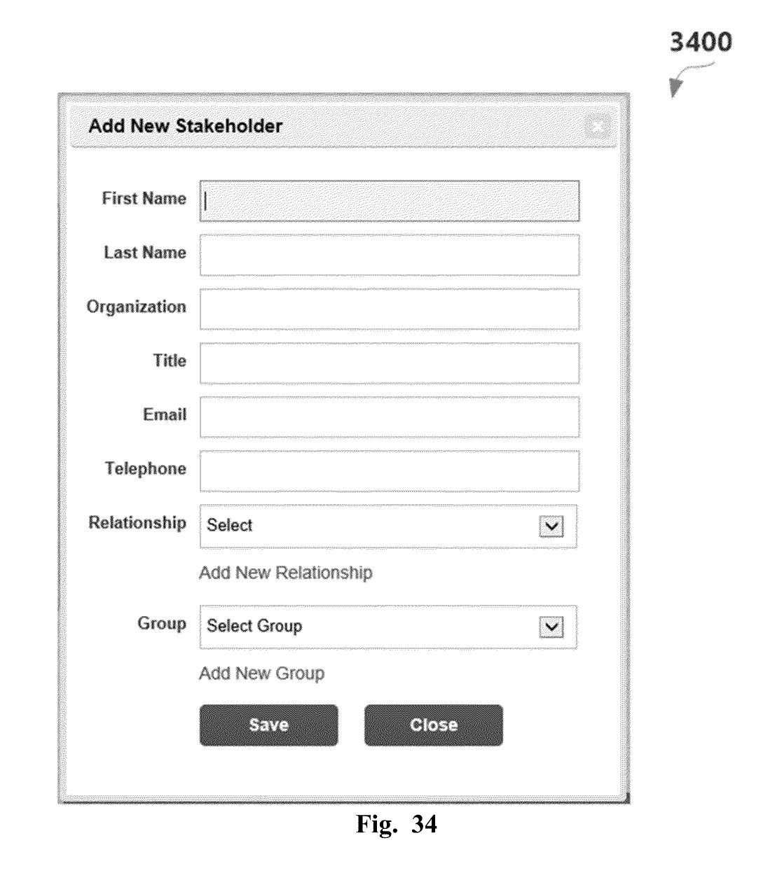

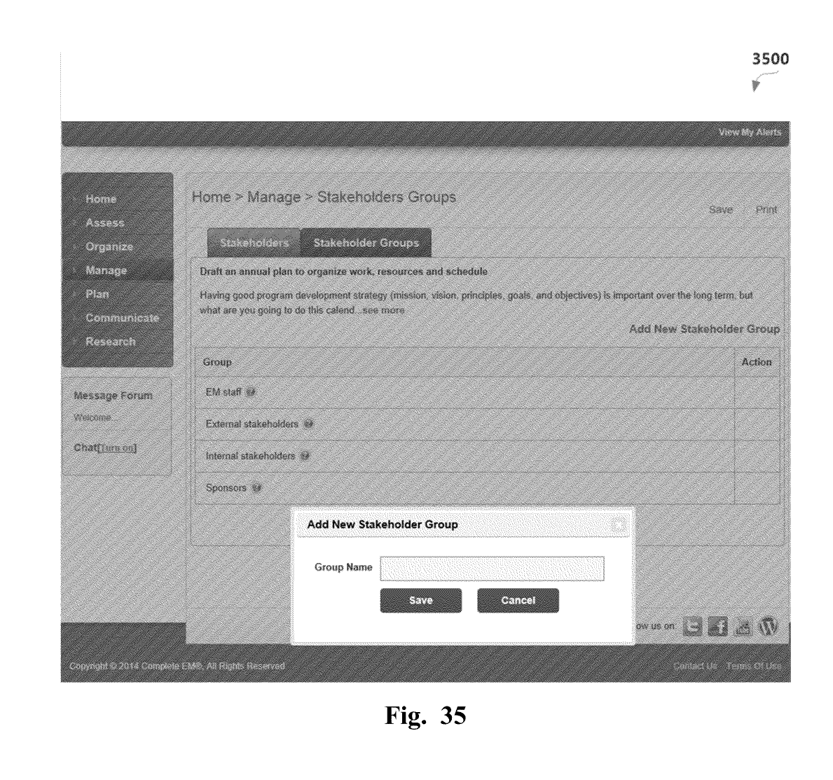

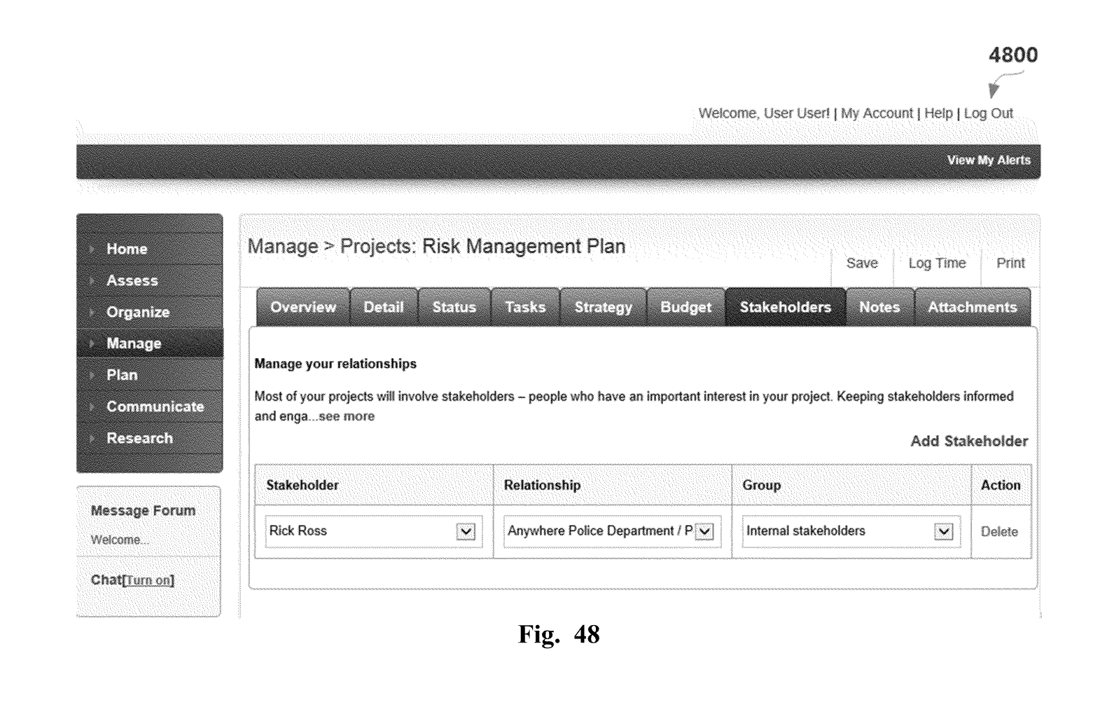

Working effectively with individual stakeholders involves knowing their program interests, organizational roles, and capabilities. Working well also involves facilitating their involvement in one or more projects and tracking how this involvement affects agency relationships. Whereas agency relationships are critical, a risk manager's relationship with one or more stakeholders from each agency is critical to affecting the agency relationship. FIG. 34 is a computer screenshot of a preferred embodiment that illustrates how a system user will identify individual program stakeholders and assign them to a new or existing relationship. To make communication easy and fast with groups of stakeholders, users can also assign each stakeholder to a pre-established or custom group of stakeholders. FIG. 35 is a computer screenshot of a preferred embodiment that illustrates how system users can also create custom groups of stakeholders. These groups are used to quickly generate emails and text messages to certain collections of stakeholders when information about a program outcome or activity needs to be communicated. FIG. 48 is computer screenshot that illustrates how a preferred embodiment relates stakeholders to every project. In this way, whenever new information about a project emerges, a risk manager can quickly and effectively relay this information to all project stakeholders. It will be apparent to those of ordinary skill in the art of risk management and in view of the disclosure herein that the notion of identifying, defining, and managing key stakeholders, relating stakeholders to specific projects and, thus, to strategies, priorities, and outcomes is a novel concept.

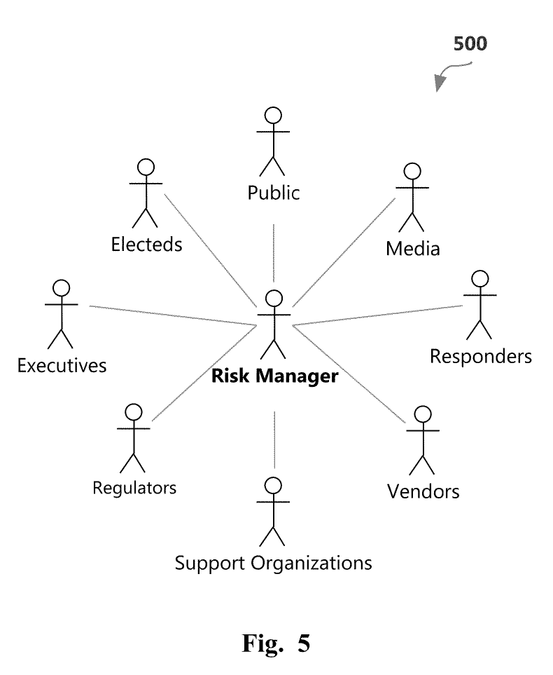

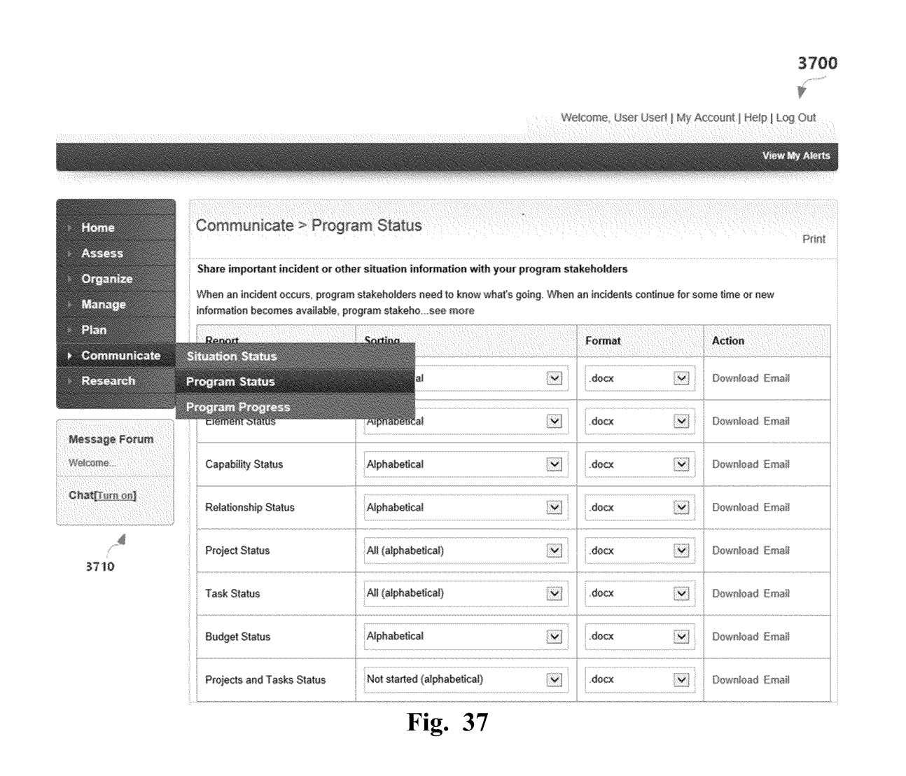

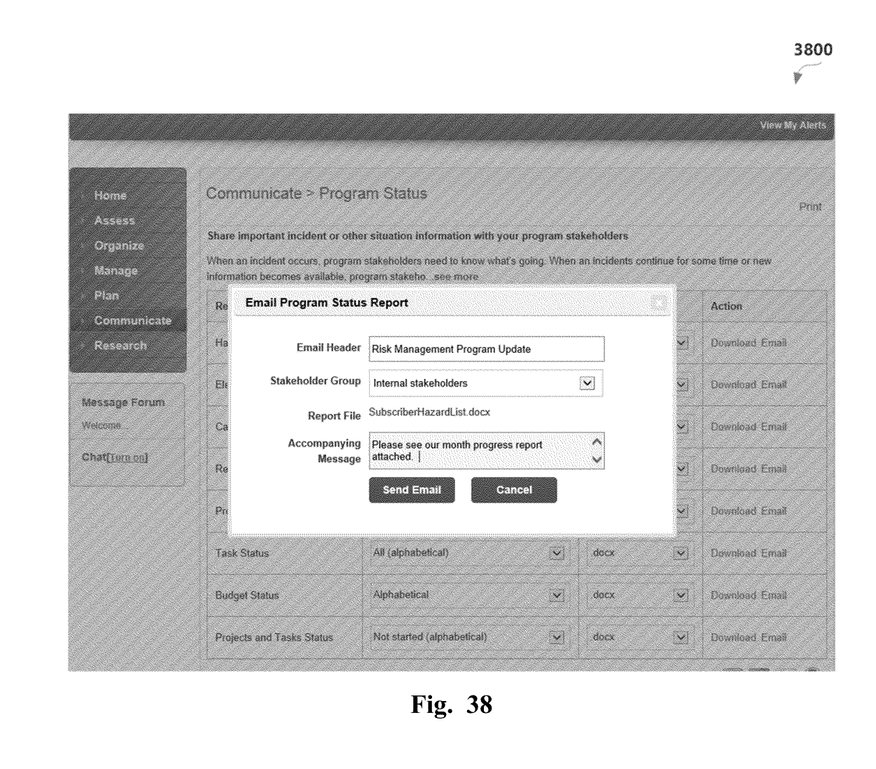

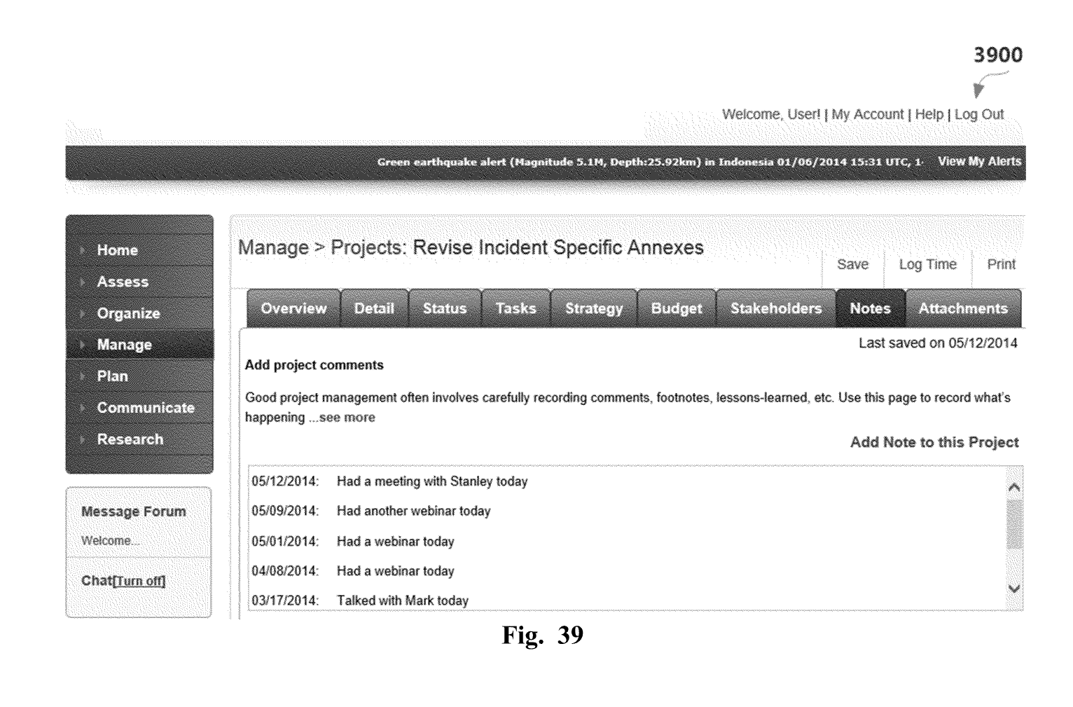

Many program stakeholders will have little time to devote to risk management activities. To them, risk management is an ancillary task for which another—an enterprise risk manager—is primarily responsible. Because stakeholder involvement is critical to program success, risk managers strive to create compelling, instructive, and efficient engagements for a variety of stakeholders. FIG. 5 is a diagram that illustrates the various types of program stakeholders a risk manager must engage. Using the results of processes to define and organize stakeholder relationships, FIGS. 37-39 illustrate how a preferred embodiment is used to ensure adequate and efficient engagement with program stakeholders. FIG. 37 is a computer screenshot that illustrates a communication menu by which a user can choose to send several types of automatically-generated documents, including assessment results, project updates and program status reports. Using a message forum or chat feature 3710, risk managers and system users can also communicate with either the entire user community or with each other. FIG. 38 is a computer screenshot that illustrates how stakeholders and stakeholder groups are included quickly in program communications. FIG. 39 is a computer screenshot that illustrates stakeholder access to project-related notes. It will be apparent to those of ordinary skill in the art of risk management and in view of the disclosure herein that the notion of pre-identifying members of risk management stakeholder groups and the information they require to perform their work for the purpose of quickly sending them program information via email, SMS or other electronic message is a novel concept.

Overcoming the effects of working with large numbers of stakeholders and inordinately large amounts of work can be accomplished with many methods. Specifically, and as they relate to a preferred embodiment, methods for managing these effects include:
a. Organizing—Systematic use of organization techniques and tools to reduce unnecessary or duplicate efforts;
b. Streamlining—Process and outcome re-engineering to simplifying work and outcomes; and
c. Automating—Employing information technology or other machine processes to perform work normally performed by humans to save time, money and resources.
   Five applications of these methods are embodied herein to produce significant efficiencies in risk management program development and are described below.

The word dashboard describes an analog or digital technique and tool used to quickly share information with a user. Dashboards are particularly helpful as a means to display detailed, dynamic, complex or extended data sets because they make information readily available can present it with useful context. They also provide for better organization of information and can automate certain information management tasks. When dashboards are interactive (i.e., when computer-generated dashboards with GUIs provide interactive visual representations and utility like hyperlinks), they can provide a streamlining value to system users. FIG. 8 (a block diagram that illustrates the notion of a program management dashboard) previously described as a tool to easily keep track of many program outcomes. As such, it offers a valuable tool for organizing a risk management program. FIG. 10 is computer screenshot of a preferred embodiment—a dashboard that shows how program outcomes (described in the figure as “issues”) can be represented as hyperlinked text 1020, thereby facilitating immediate access to more detailed information like that shown in FIG. 13. Hyperlinks add utility as a program organization tool and automate access to additional data. By adding menu items 1010 to a dashboard as well, users can access streamlined processes specifically designed to perform risk management tasks. This organization, and the streamlining and automation of tasks, enables risk managers to work more quickly, more productively and with greater efficiency, thereby mitigating to some extent the challenge of having to work with multiple stakeholders. It will be apparent to those of ordinary skill in the art of risk management and in view of the disclosure herein that the notion organizing, automating, and streamlining risk management information and work by utilizing a computer-generated dashboard is a novel concept.

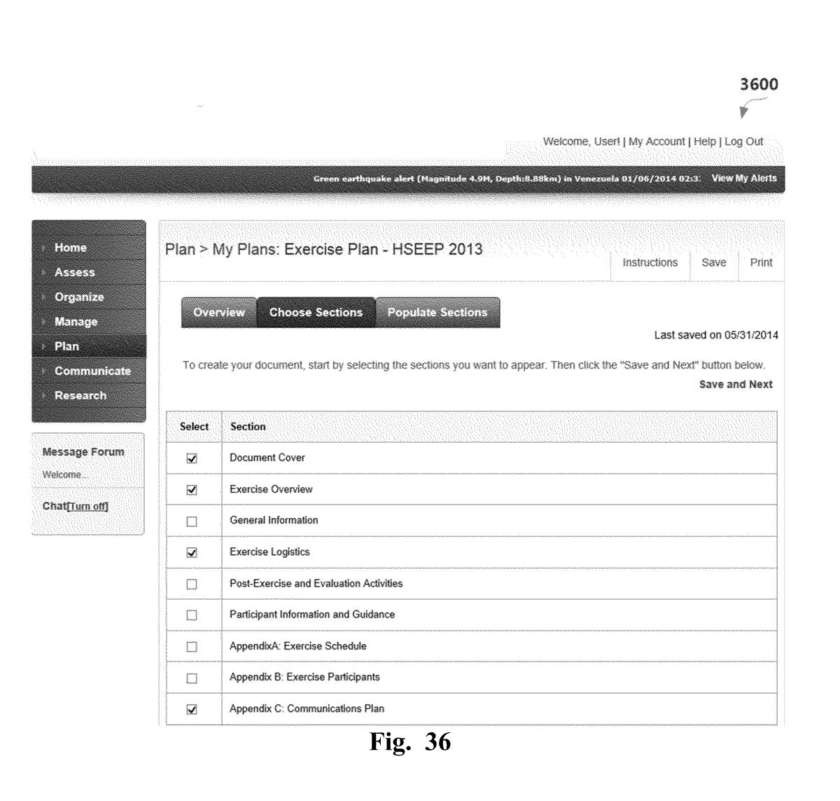

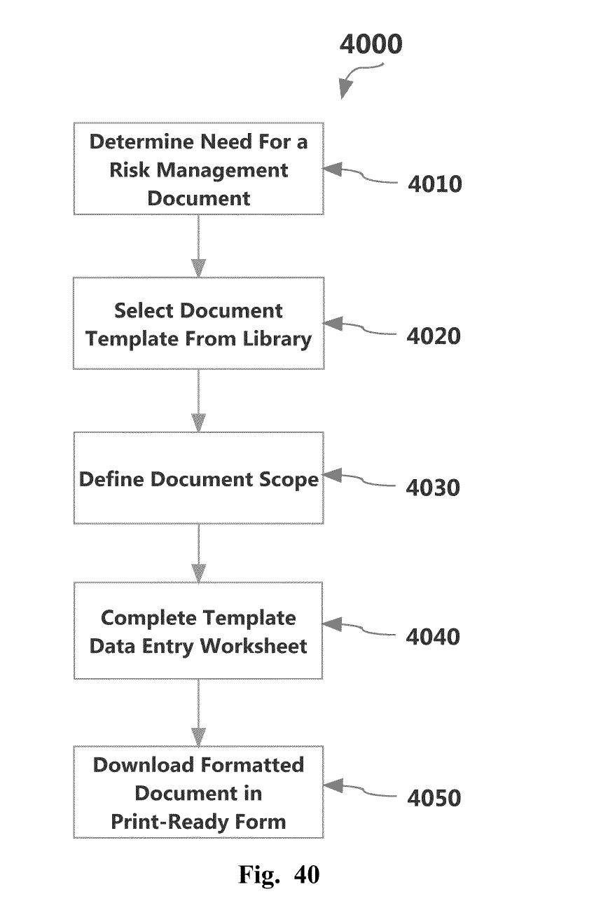

By some accounts, risk managers spend approximately 30-50% of their time developing documents, many of which have already been developed for a similar purpose by other risk managers. FIG. 40 is a block diagram that illustrates one preferred embodiment that allows system users to easily create program documents from templates, thereby eliminating the need to create most documents from scratch. Using this embodiment, a user first determines a need for a particular document 4010, then selects an appropriate template from an extensive library of available templates 4020. The user then edits document identification and selects which parts of a document template outline they wish to develop 4030. Based on a user's customized selection of a document outline, a document table of contents and data entry worksheet 4040 are generated to elicit the necessary information from the user (working now as the new document author). Using the information from a completed worksheet and document template, the system generates a print-ready document 4050 by inserting user data as XML data into a document template saved as XML. FIG. 36 is a computer screenshot that illustrates a user's selection of a particular document outline (step 3 of the 5-step process illustrated in FIG. 40). As a result of not having to edit each page of a document, repeat words or phrases, edit document formatting or construct sentences, users are able to dramatically save time generating program documents. With most of the 100-200 program outcomes requiring some degree of document development, this embodiment can save risk managers hundreds of hours of work each year. It will be apparent to those of ordinary skill in the art and in view of the disclosure herein that the notion streamlining and automating the task of risk management document development by generating, by means of a computerized process, customized user documents by combining user data from worksheets with document templates is a novel concept.

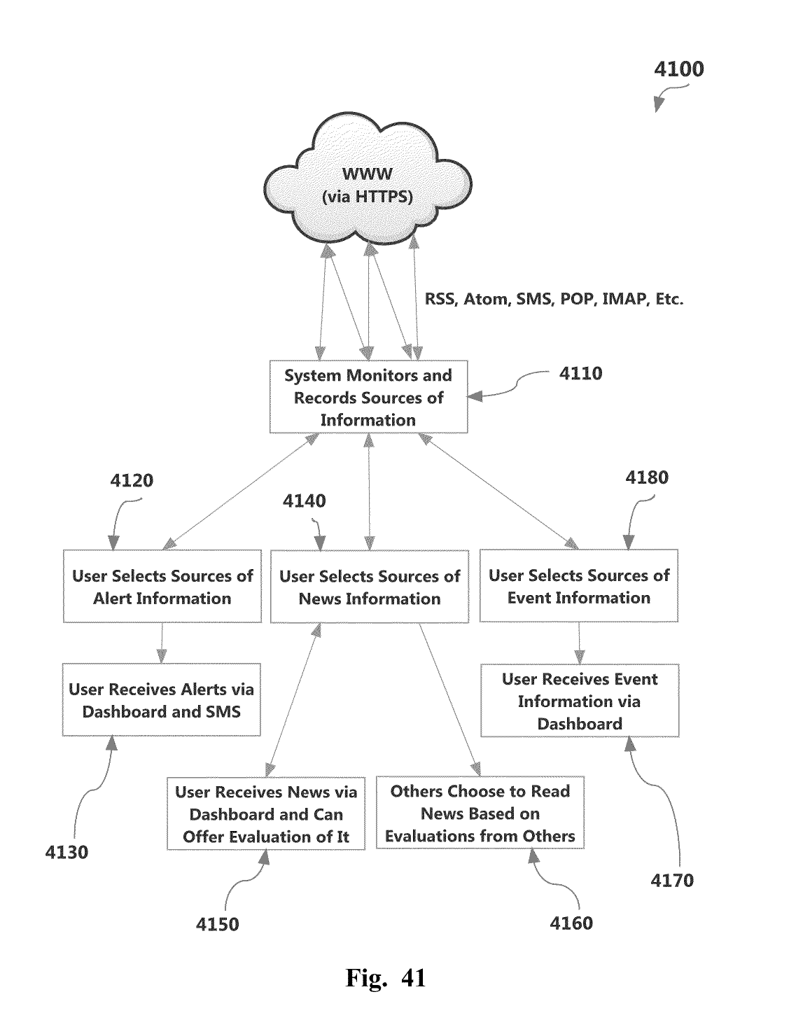

Risk managers must monitor multiple sources of information regularly, if not constantly. If useful information about risk, the art of risk management, or if indications of a risk event (emergency or disaster) becomes available, risk managers need to know about it, have an opportunity to consider and act upon it, and to notify others. There are numerous sources of information and several methods for gathering and disseminating it. Monitoring and managing multiple sources of information that arrive in different formats as MMS, RSS, SMS, telephone, pager and traditional mail messages is problematic. It subjects a risk manager to a daunting schedule of collection, analysis and dissemination which, in turn, may jeopardize program effectiveness. Processes and tools that streamline, automate, organize and share information collection save risk managers significant time, allow them to operate their program with less staff, and engage more stakeholders. FIG. 41 is a block diagram that illustrates one preferred embodiment for easily monitoring and utilizing a vast number of information sources using a simple, single-page GUI. Instead of subscribing to various sources of information, and making use of different services and devices, system users simply visit a webpage to select their preferences for alerts 4120, news 4140, and events 4180. A Web-server and associated Windows Services then regularly and continuously monitor sources for information 4110 before relaying it to system users, based on their preferences 4130, 4150, 4170. Because a large volume of news may be available, users are also encouraged to evaluate news 4150 and indicate whether it is advantageous or non-advantageous for others to read it, thereby reducing the need for others to read news of little or no apparent value to others 4160. FIG. 32 is a computer screenshot that illustrates how a user may select alert and news sources which are relevant to their program. FIG. 10 then illustrates, by way of computer screenshot, a preferred embodiment for quickly accessing alerts or news 1030 again, based a user's preferences. It will be apparent to those of ordinary skill in the art of risk management and in view of the disclosure herein that the notion of streamlining and automating the collection, aggregation, dissemination and evaluation of risk management alerts, news, and event information by means of a computerized process and dashboard is a novel concept.

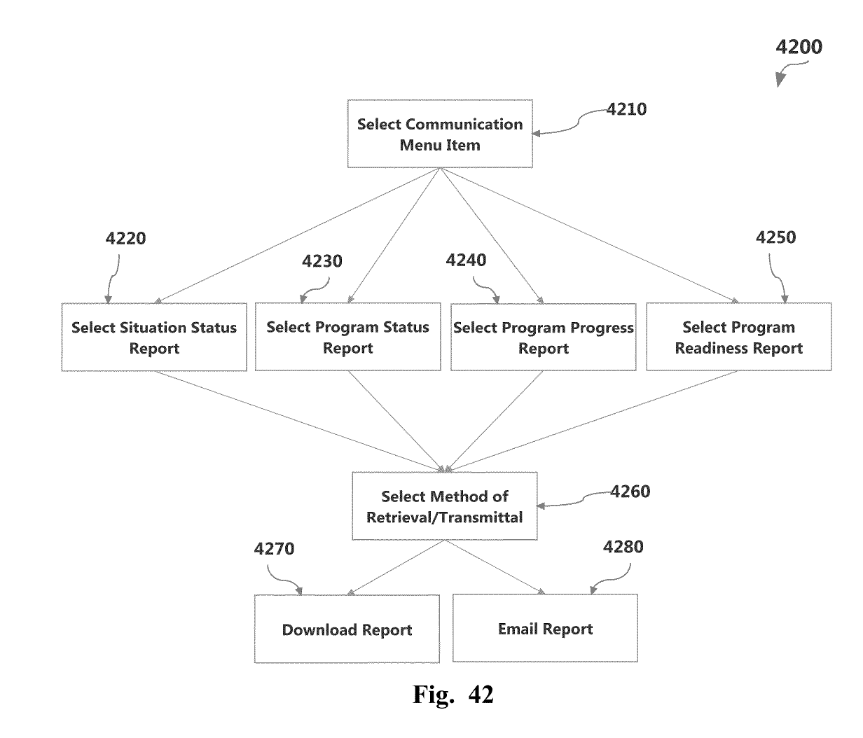

With so many activities and outcomes to coordinate, risk managers have a lot of program performance data to monitor. The status of program fund sources, projects, work plan and strategic plan progress, and overall program readiness are just a few examples of information that risk managers have to collect, manage and share with program stakeholders. FIG. 42 is block diagram that illustrates a preferred embodiment to make it much easier to generate and share program development reports. System users navigate to the Communicate menu item 4210 and choose from four groups of reports. Situation status reports 4220 allow users to quickly communicate an imminent or actual risk event in progress. Using the document development from template capability described and illustrated in FIG. 36 system administrators are able to load any number of report formats to support the various requirements of users. For example, a user may choose to report a risk-induced event-in-progress (i.e., a structure fire) using a quick incident report or a long-form situation report. The user simply needs to choose which template to use and, thus, which report to complete. The report is then completed by submitting using an online form that answers template-specific questions. Users may also choose one of several reports available under the Program Status 4230, Program Progress 4240, or Program Readiness 4250 reporting sub-menus. Status reports generate a current snapshot of program status. Progress reports display changes to program status between status reports of different dates. Readiness reports display the condition of certain program outcomes that users define as conditions of readiness. Once selecting a report, a user then chooses an output format for the report data 4260 (i.e., pdf, docx, xlsx file formats) and then chooses whether to download the report 4270 (if, perhaps the users wishes to email the report or incorporate it into a separate document) or they can email it 4280 to stakeholders and stakeholder groups described earlier. FIG. 37 is computer screenshot that illustrates one preferred embodiment of such a GUI. It will be apparent to those of ordinary skill in the art and in view of the disclosure herein that the notion of streamlining and automating the process of risk management program performance reporting and presenting this as current situation, program status, program progress, and program readiness reports is a novel concept. By streamlining and automating reporting activity, risk managers can be expected to spend much less time determining and communicating program performance for stakeholders.

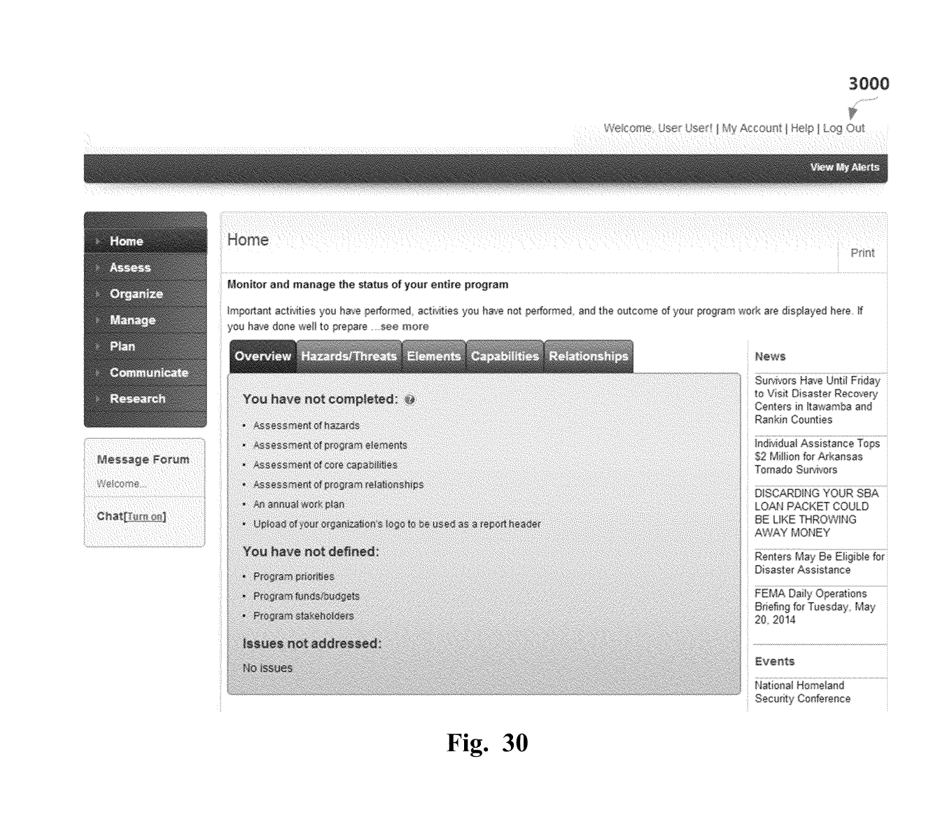

At various times throughout the tenure of any risk manager, they will require help with program development. However, the broad nature of the art and, consequently, the need for specialization to apply the art for certain types of organizations, often makes it difficult to find good help quickly. Having resources that risk managers can use for various forms of help can save them time, resolve program development challenges and enhance program success. FIG. 8 is a block diagram that illustrates the utility of various embodiments described herein to help system users define, organize, track and manage program outcomes. Getting Help 850 embodies various methods. When attempting to build a program from the beginning or while managing a program with many interdependent outcomes, a risk manager may find it difficult to keep track of systematic deficiencies in program development. For example, a risk manager may have already defined hazard/threat outcomes and capabilities, but stopped short of defining relationship or program element outcomes. It is useful to a risk manager to quickly identify and resolve these shortcomings. FIG. 30 is a computer screenshot showing examples in one preferred embodiment of how certain metrics, program assessment data, and system logic is used to identify systematic shortcomings in a user's program development effort. The text in the shaded area (center of the figure) prompts a user where additional program development work is needed. This text then hyperlinks to system applications (views and related system logic) that allow a user to complete this work and overcome identified shortcomings. It will be apparent to those of ordinary skill in the art of risk management and in view of the disclosure herein that the notion of a computer-implemented process for identifying, displaying and resolving system program development shortcomings and providing help to resolve these shortcomings is a novel concept.

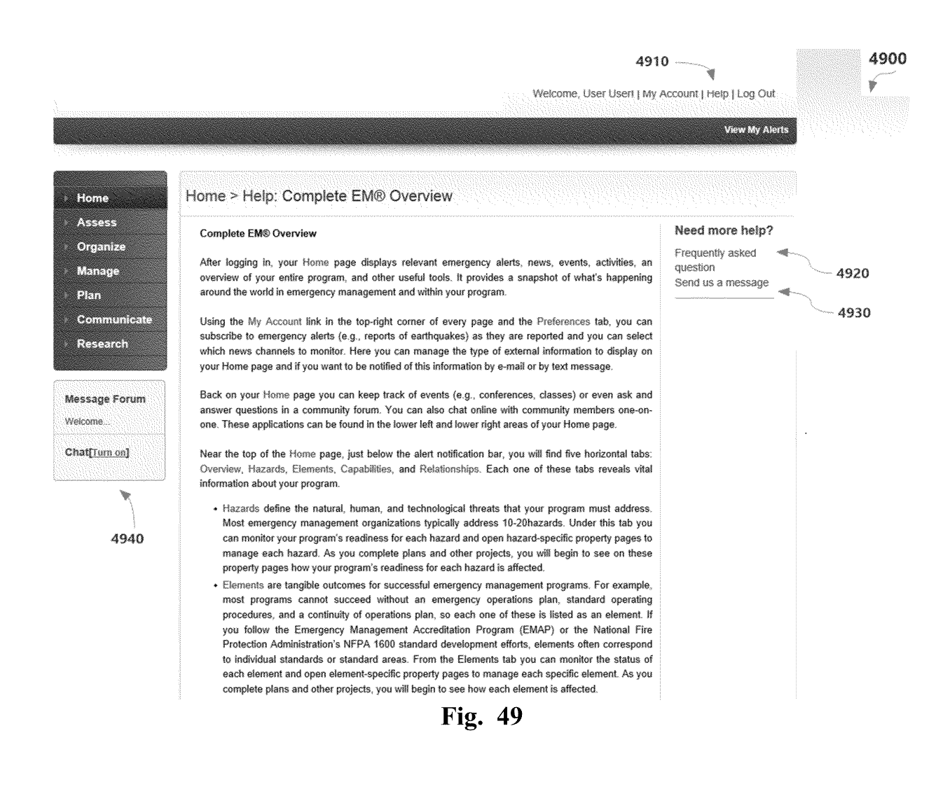

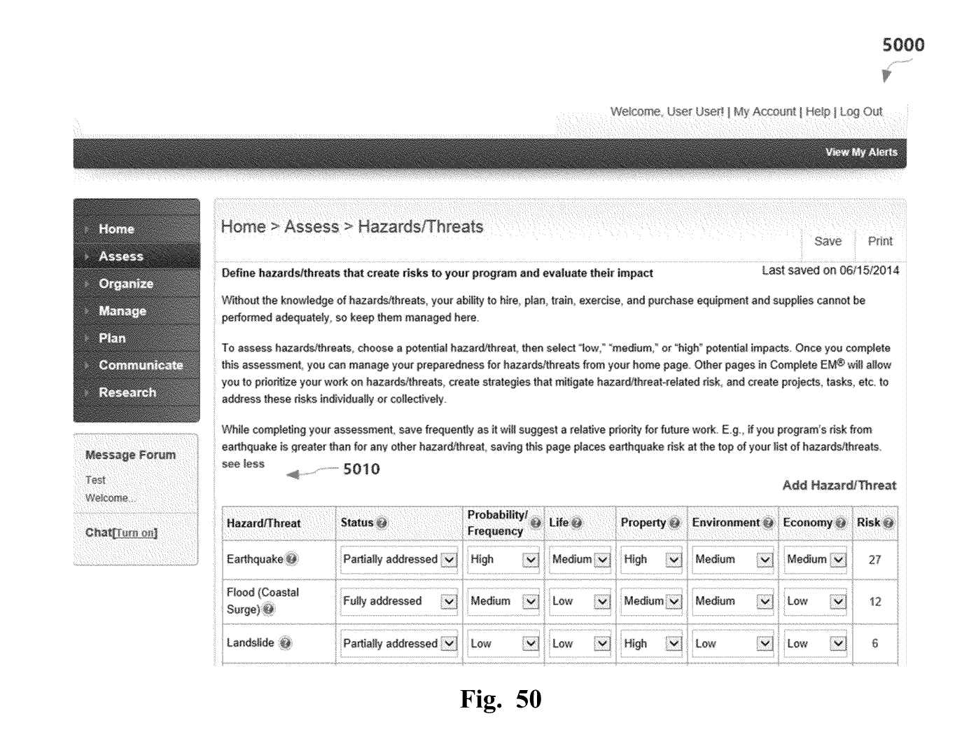

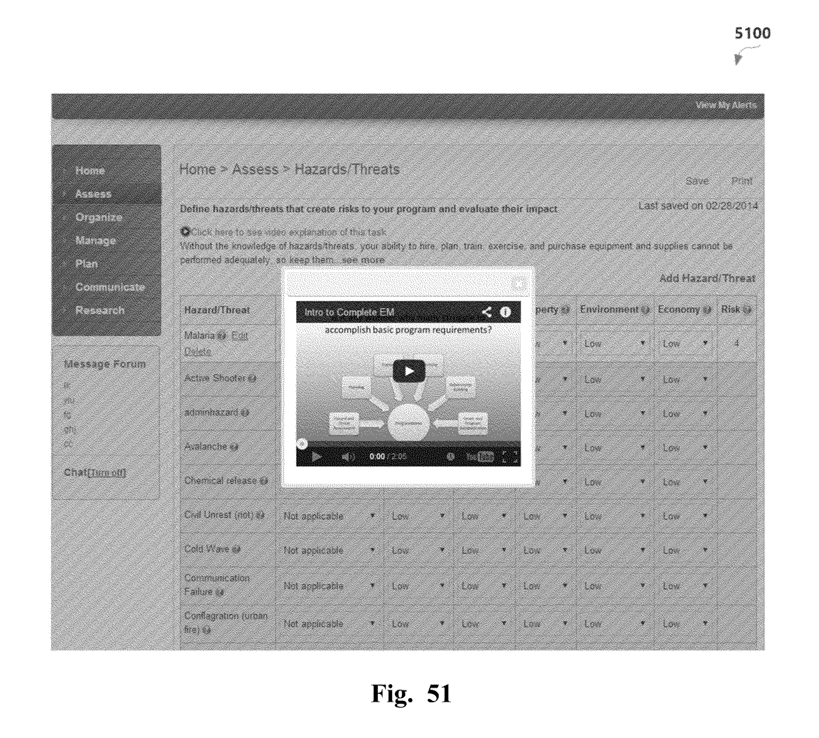

Anticipating that some users may be new to the practice of risk management or seek assistance with program development, a preferred embodiment provides several opportunities that enable learning. FIG. 49 is a computer screenshot that illustrates the utility of a system help menu. A Help hyperlink 4910 is rendered on all system pages to ensure that each user has access to risk management program and system help while developing their individual program. A risk management program development primer 4920 is provided as a stand-alone document to facilitate learning of a quick overview of typical program requirements and system capability to support these requirements. If a user wants to request risk management program advice or system support, they can send an email 4930 or open a direct chat 4940 with a system administrator/risk manager. In most cases, however, it will be sufficient for a risk manager to read a primer or watch an instructional video to guide risk management activities. FIG. 50 is a computer screenshot that illustrates program development help text 5010 and FIG. 51 illustrates instructional videos created for pages that involve a risk management concept conducive to explanation using multimedia. It will be apparent to those of ordinary skill in the art of risk management and in view of the disclosure herein that the notion of guiding risk managers through a process of comprehensive program development, via one or more methods using a computerized process is a novel concept.

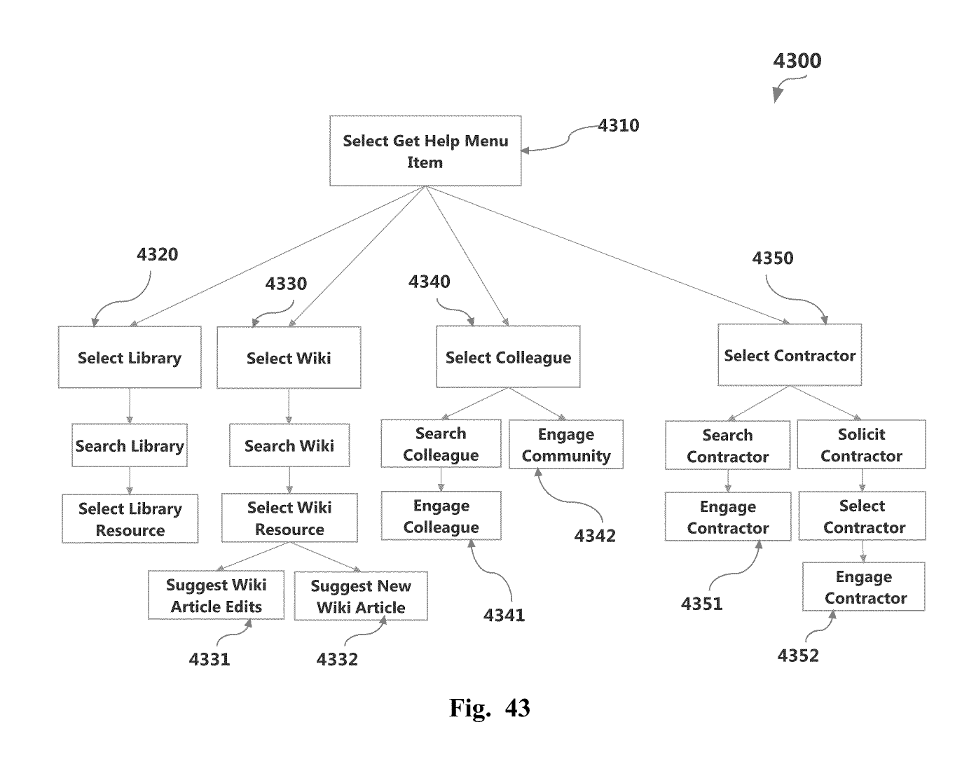

FIG. 43 is a block diagram that illustrates a preferred embodiment and how risk managers gain additional help with their program development efforts. User may choose to view an online resource library 4320 that contains text files, media files, and a summary of each resource. When a resource library document will not suffice as help and when a topic primer may be needed, a user can search for, open, and read these primers on a system Wiki 4330. Insofar as users may have information to contribute as they learn from a primer, the system allows a user to suggest edits 4331 to existing Wiki articles or to suggest new Wiki articles 4332. Perhaps for situations in which information from risk management colleagues is needed quickly, users can choose to get help from a colleague 4340 which, in turn, allows them search for and engage a colleague in a secure online chat 4341 or to engage the entire community using an online question and answer (Q&A) forum 4342. When risk managers need help-for-hire, a user can choose to engage a contractor 4350. They may search for a particular contractor directly 4351 or solicit contractors from an established list of contractors before engaging one or more of them 4252. It will be apparent to those of ordinary skill in the art of risk management and in view of the disclosure herein that the notion of making help available to a risk manager using a resource library, Wiki, individual and group communications and contractors using a computerized process is a novel concept.

Disproportionately Small Level of Influence and Control—

In addition to challenges inherent in providing risk management support to hundreds or thousands of people, risk managers also exercise very little control or influence over other units within an organization. This lack of influence and control requires risk managers to increase their credibility and influence with program stakeholders and not just their productivity (the latter was described in previous sections). For example, a municipal emergency manager (a type of risk manager) may be responsible for preparing an entire city for emergencies. Doing so requires the effort of all city departments, but these departments also have their primary work to accomplish, so their participation may be difficult to obtain. Securing mayoral or city manager support by means of edicts that require all stakeholders to participate in risk management efforts might be helpful, but such edicts must be used sparingly, so as not to make them commonplace, resented, and counter-productive. Risk managers, therefore, must employ other techniques to obtain and maintain good participation for their program. These techniques involve demonstration of:
a. A solid understanding of the concept of risk and methods for managing it well;
b. An appreciation for the current status and future requirements of their enterprise risk management program;
c. Effective coordination of program activities;
d. Effective collaboration; and
e. An appreciation for the individual and collective time of program stakeholders and the sacrifices which are sometimes necessary to make program success possible.
   Several novel approaches used to meet these needs of risk managers are described below.

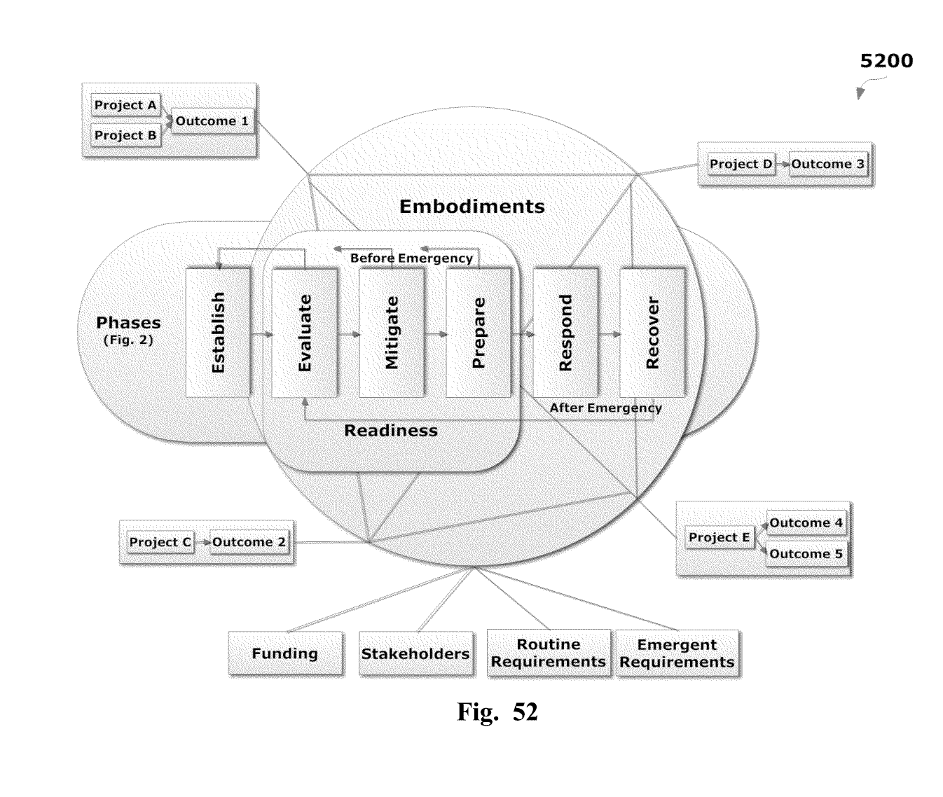

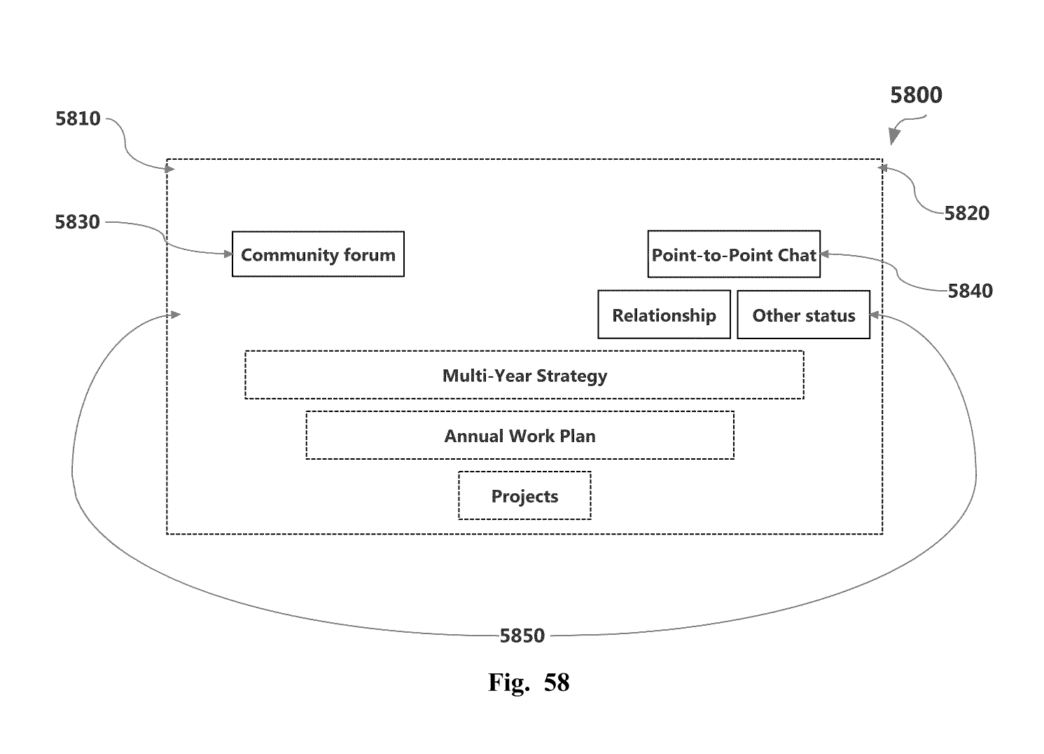

Demonstrating the current status and future requirements of a risk management program can be daunting tasks. Implementing program development work can be even more challenging. It is important for risk managers to understand, communicate and act on all information within the context of a comprehensive emergency management program. Those who do not, risk the inattentiveness, ambivalence, or confusion of stakeholders and the missed opportunities or program failures that may result. FIG. 52 is a diagram that describes the whole of risk management in context. It illustrates the six phases of risk management; the underlying efforts to prepare before a risk-induced event occurs; the influence of stakeholders, funding, routine and emergency program requirements; projects that accomplish program outcomes; and the value of a system, process, and tools to relate all of this and to facilitate program development. Given so many aspects to risk management, the dynamic nature of related activity and the interdependency of outcomes, the need for a program management dashboard becomes evident. FIG. 8 is a diagram that illustrates the dashboard functions of a preferred embodiment. Using the dashboard and in light of all that has been described herein, risk management becomes much easier when a user employs such a system to define and manage program success 810. FIG. 58 describes this portion of the dashboard in more detail. System users employ the dashboard to monitor various sources of emergency and disaster alert information 5810; monitor less urgent but still relevant news 5820; participate in a system user forum 5830 where they can quickly exchange information with peers; communicate directly with a single peer 5830 or program stakeholders 5840; and manage different sets of outcomes defined by a user 5850. This dashboard then facilitates processes illustrated by FIGS. 11, 14, 19, 40-43, 53-56 to help a user define, assess, organize, and achieve program outcomes. Retuning to FIG. 8 for context, we see that users create and manage dashboard information by performing assessments 820; organizing priorities, strategy, and work 830; managing that work 840; getting help with that work 850; and communicating issues, progress and results to program stakeholders 860. Because certain circumstances may require risk managers to take actions specific to a risk management phase, the preferred embodied dashboard also facilitates mitigation 891, preparedness 892, response 893 and recovery 894 processes. It will be apparent to those of ordinary skill in the art of risk management and in view of the disclosure herein that the notion of organizing, automating, and streamlining risk management information and work by utilizing a computer-generated dashboard is a novel concept.

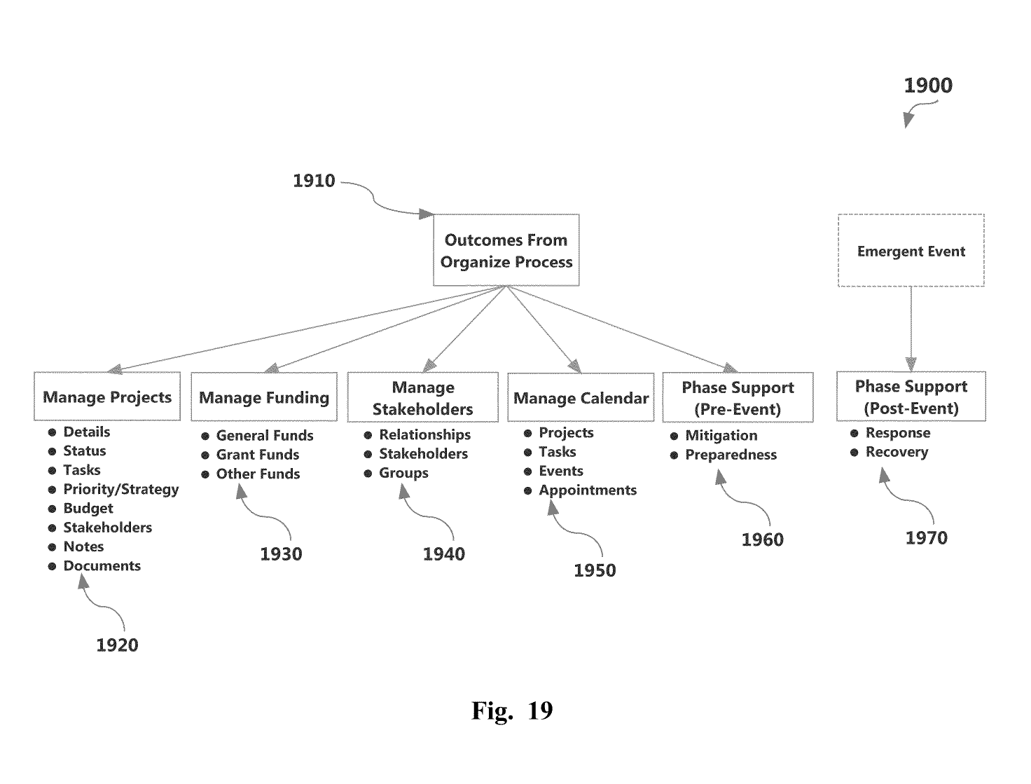

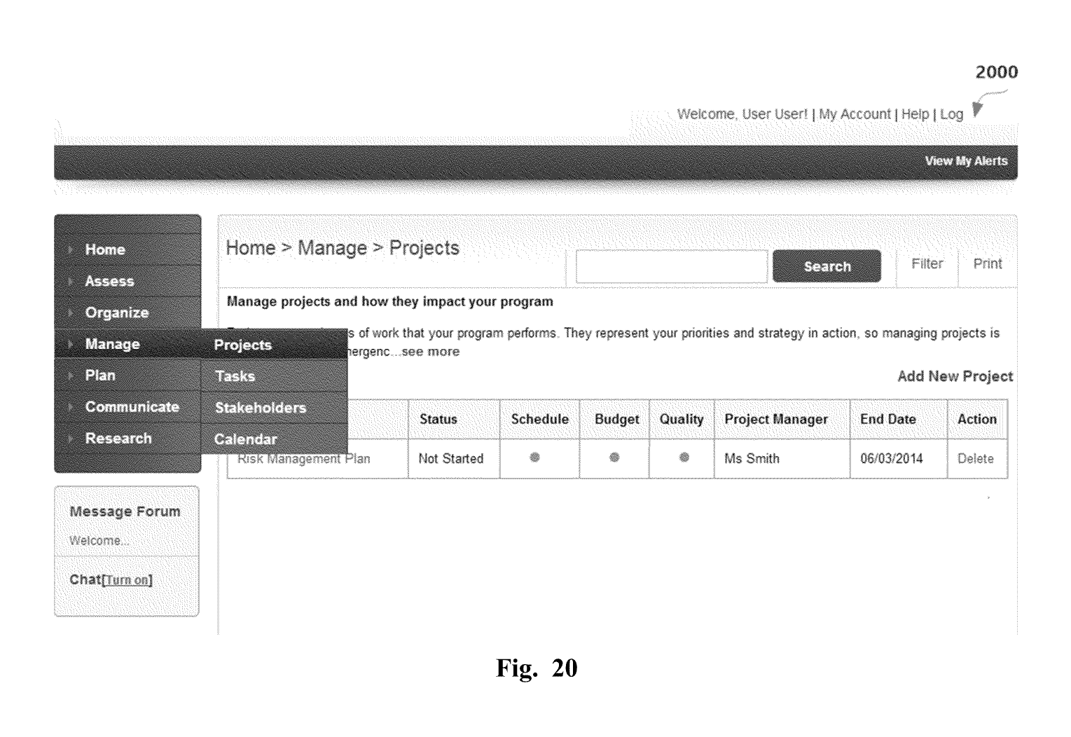

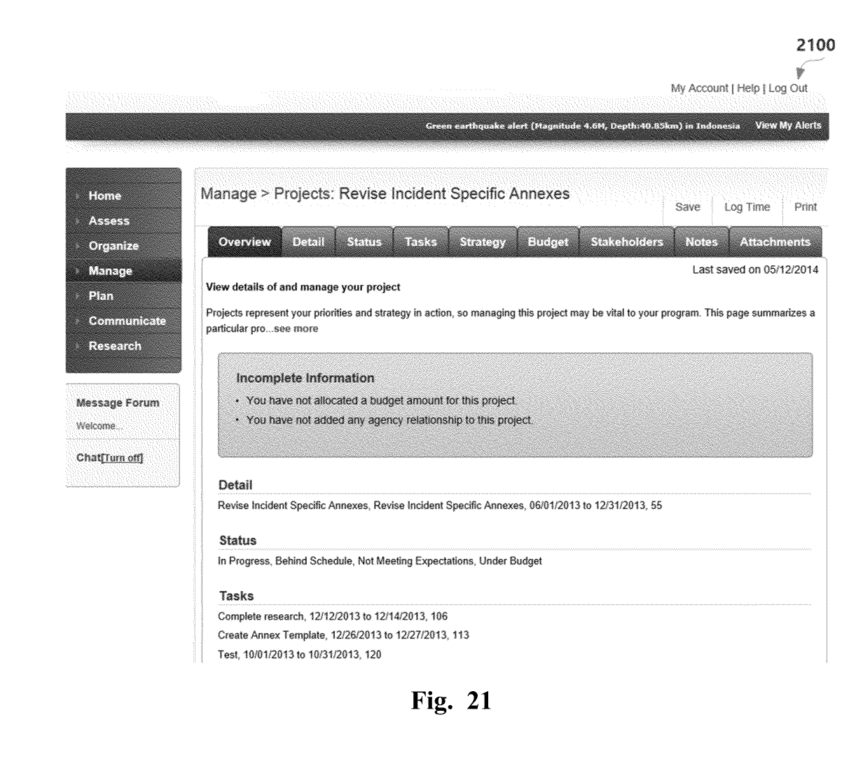

Transforming all manner of program inputs into a comprehensive set of outcomes that accomplish risk reduction and create a readiness to respond and recover is the purpose of all risk management programs. This disclosure has already described preferred embodiments that help to identify, assess and organize this program work. This section will now describe how a preferred embodiment helps risk managers accomplish program outcomes. FIG. 19 is a block diagram that illustrates the overall process used in one preferred embodiment to manage the implementation of program activities. Using priorities, strategy and work planning conducted during the organization processes 1910, a system user manages projects 1920 as a means to accomplish all planned work. The system relates projects (collectively, program activity) to all program outcomes, so good project management not only results in good performance of a risk management project portfolio but is also instrumental in monitoring, measuring and affecting program performance, including program readiness. FIG. 20 is a computer screenshot that illustrates an overall project management page in a preferred embodiment. It is rendered as a view by selecting “Manage” from the main system menu (left navigation) and “Projects” from the sub menu. This rendered view also summarizes project title and status information about all projects using both text and graphic representations. By clicking the project title (a hyperlink), a user is redirected to a project profile page illustrated by FIG. 21, that displays several typical tabbed pages for each project, including:
a. Overview Tab—Displays a summary of all project metadata;
b. Detail Tab—Allows a user to view and edit a project name, start date, end date, and project manager;
c. Status Tab—Allows a user to view and edit project status with regard to activity, schedule, budget and quality;
d. Task Tab—Allows a user to create, view and edit supporting task information, including the name, schedule, assignee, and expended duration of the task;
e. Strategy Tab—Allows the user to create, view and edit relationships between this project and program outcomes, priorities and strategy;
f. Budget Tab—Allows the user to create, view and edit funding information relative to the project;
g. Stakeholders Tab—Allows the user to create, view and edit stakeholders involved in the project;
h. Notes Tab—Allows users to create, view and edit a record of all project notes; and
i. Attachments Tab—Allows users to add, download and delete documents that relate to the project.
   It will be apparent to those of ordinary skill in the art of risk management and in view of the disclosure herein that the notion managing program success by managing a certain set of projects which are relate to program outcomes and that doing so by means of a computerized process are novel concepts.

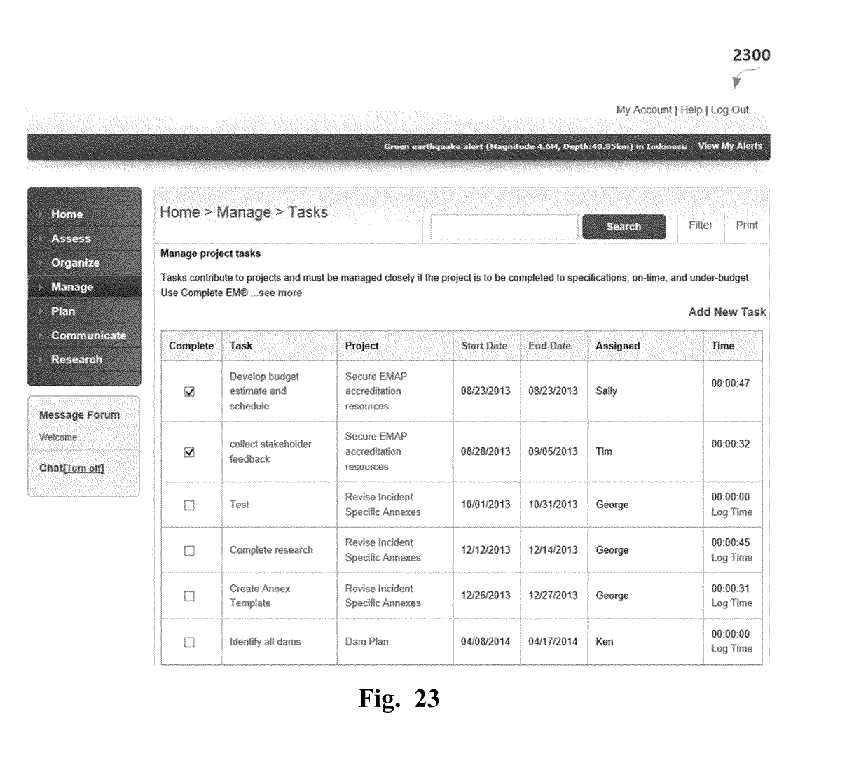

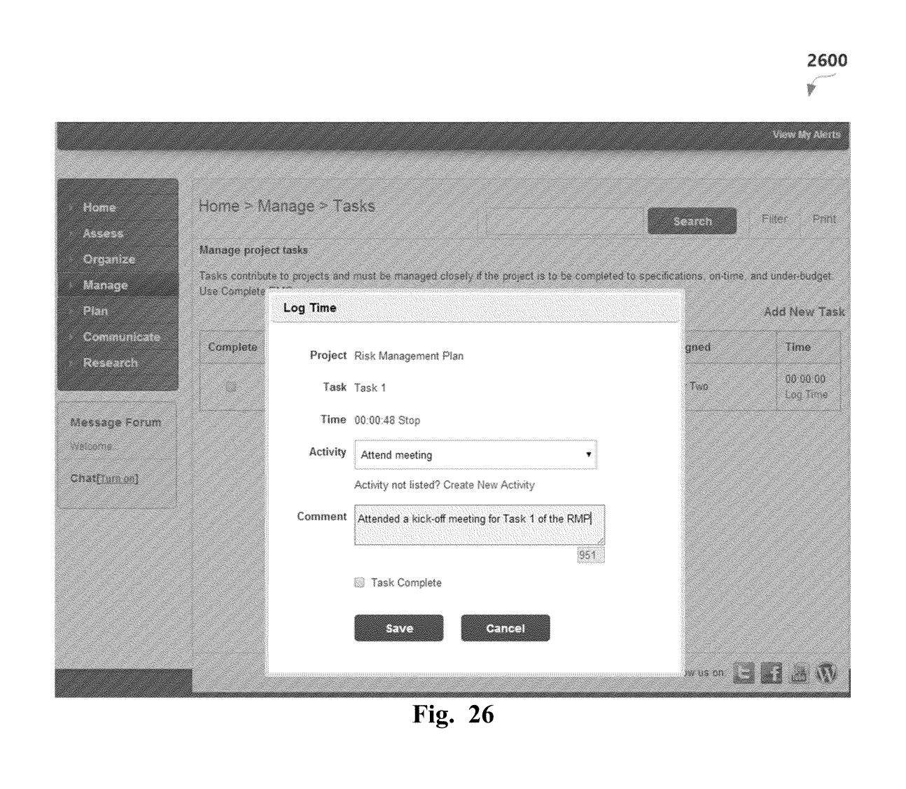

FIG. 23 is a computer screenshot that illustrates the “task” GUI in more detail. With this view, users are able to manage all tasks that support a project. Similar to the project overview GUI this view shows which project a task supports, when the task is scheduled to start and end and who is assigned to the task. In addition, users can log time on the task and categorize this time by activity type. This capability allows the system to record all program time spent in an activity, on a task, for a project, toward a goal and in many other permutations of time-activity-outcome reporting. This allows a user to record time investments in each program outcome and to measure the earned-value of work. FIG. 26 is a computer screenshot that illustrates this GUI as a preferred embodiment which is used to log time on a task. It will be apparent to those of ordinary skill in the art of risk management and in view of the disclosure herein that the notion of tracking time on a task, which is related to a project, which is related to a strategy, which is related to an outcome, for the purposes of reporting time expended on any program activity or outcome, is a novel concept.

FIG. 19 is block diagram that illustrates a preferred embodiment and the management of program cash flow 1930, stakeholder relationships 1940, program milestones and schedule by way of a shared calendar 1950, and phase-specific support 1960 and 1970. It will be apparent to those of ordinary skill in the art of risk management and in view of the disclosure herein that the notion of managing all program activity by managing projects, funding, stakeholders, schedules or calendar, as well as phase-specific support including establishment, assessment, mitigation, preparedness, response and recovery, is a novel concept.

Processes and tools for the Establish and Assess phases of risk management have already been described. The next sections examine the remaining four phases as subsets of the Manage process in more detail and how embodiments described herein support these phases.

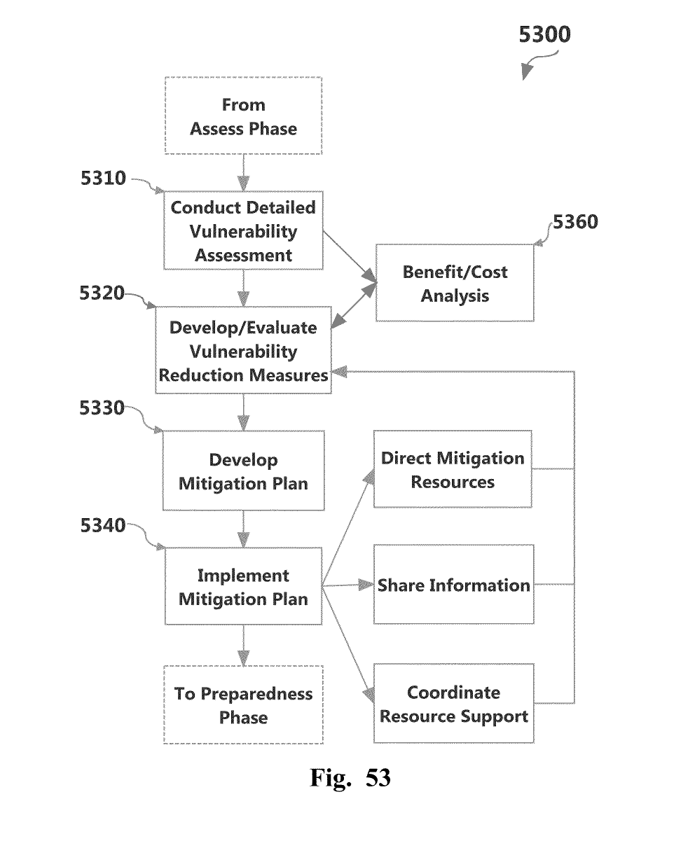

Mitigation is the phase of risk management activity that occurs after assessment and before preparedness. The purpose of the mitigation phase is to reduce risk by reducing vulnerability. Risk is a function of vulnerability and potential impact. The more vulnerable something is to a hazard or threat, the more risk is involved. The more serious impacts may be felt as a consequence of vulnerability, the more risk is involved. Mitigation focuses on reducing vulnerability. Preparedness, response and recovery activities reduce impacts. FIG. 53 is a block diagram that illustrates the mitigation process. Using assessment information from the previous phase, risk managers focus on areas of greatest concern and conduct more detailed vulnerability and consequence analyses 5310. Using these analyses, risk managers then consider one or more alternatives for reducing risk 5320. These alternatives are then evaluated for their benefit/cost 5360. A project with a benefit/cost ratio greater than 1.0 (meaning that its quantified benefit as a risk reduction measure exceeds its cost to implement) provides a candidate for mitigation activity. When one or more good mitigation projects is identified with the help of stakeholders, risk managers then prepare a mitigation plan 5330 which is used to, make a business case for chartering one or more mitigation projects. Critical to such a business case is an explanation of each threat/hazard, vulnerability, impact, and the project or projects intended to mitigate risk. The available funding, ease implementation, useful life and other factors also factor into mitigation project selection. Risk managers then implement the mitigation plan 5340 by directing or coordinating resources and sharing information. The mitigation activity typically continues until an event occurs (thus, the mitigation phase, in one respect, can be considered concurrent with the preparedness phase) so risk may be reduced continuously until a risk-induced event occurs. FIG. 8 is a block diagram that illustrates a preferred embodiment whereby system users can identify the need for mitigation projects and use information, processes, and tools to develop a mitigation plan. Program organization (FIG. 14) and program management (FIG. 19) can also be used to relate mitigation work to various program outcomes and activities. It will be apparent to those of ordinary skill in the art of risk management and in view of the disclosure herein that the notion defining, organizing, implementing and tracking mitigation status, process and activities, and developing of mitigation plans and other products, using a computerized system and program dashboard are novel concepts.

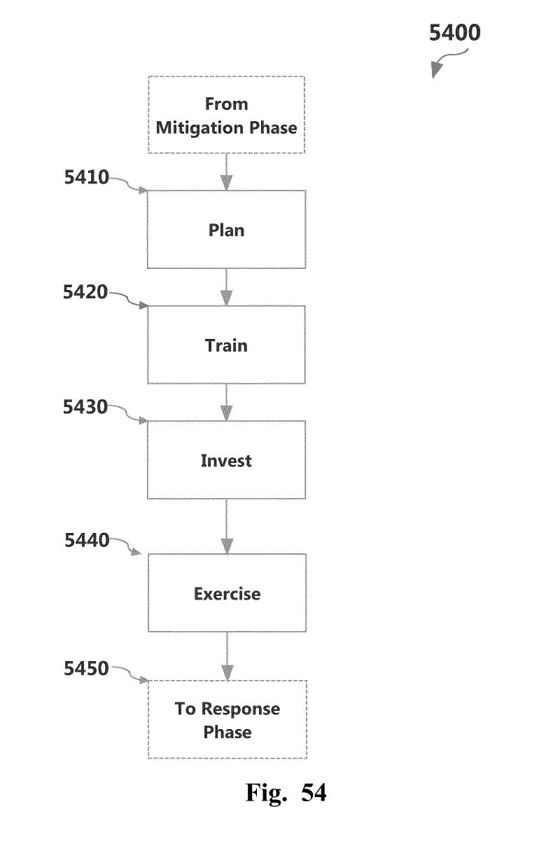

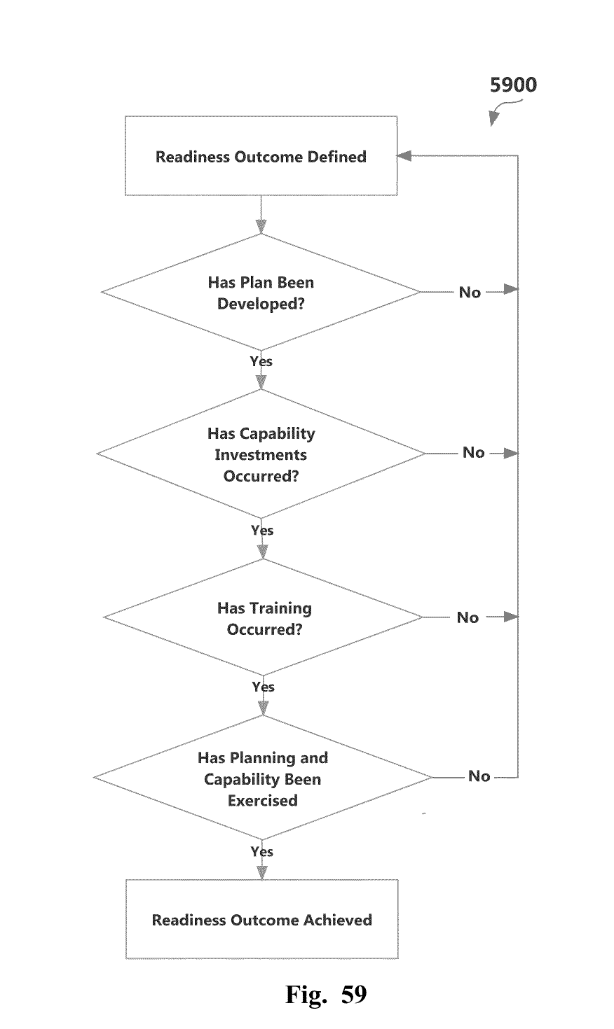

Preparedness is the phase of risk management activity that occurs after assessment and mitigation phases but before the response phase. The purpose of preparedness is to reduce risk that cannot or has not been mitigated. Preparedness involves preparing to respond and often represents the longest, most involved, and important phase of risk management. FIG. 54 is a block diagram that illustrates a preferred embodiment of the preparedness process. Following some, if not, all mitigation activities so that some degree of risk can first be mitigated, and again using outputs from assessment processes, risk managers develop plans 5410; train individuals and organizations to implement those plans 5420; invest in the facilities, equipment and supplies necessary to implement plans 5430; and then exercise and evaluate response by employing all of the previous tasks to practice a response. FIG. 6 describes the preparedness process in context with ongoing stakeholder involvement and the linear, iterative, cyclical nature of risk management. In one preferred embodiment, system users employ several processes and tools already described herein to manage the preparedness process and accomplish various preparedness tasks (i.e., project management, document development, communication, reporting, etc.). The completion of preparedness activities results in a program being ready. Completion of the entire preparedness process offers a qualitative measure of readiness. The completion of specific outputs of the preparedness process offers quantitative measures of preparedness. For example, when a program has planned, trained, equipped and exercised response to any number of hazards or threats, they may claim some qualitative measure of readiness. When a program can demonstrate planning, training, equipping, exercising, collaboration and evaluation specific to a hazard/threat, they can objectively and quantitatively demonstrate readiness. One preferred embodiment tracks planning, training, equipping, exercise, collaboration and evaluation requirements for any and all hazards/threats so that a user can easily define, measure, report, and act upon readiness as one or more program development outcomes. FIG. 59 is a block flow diagram that illustrates the logic a preferred embodied system uses to determine if a program is ready to respond to hazard/threat impacts that may come as a result of an event. It will be apparent to those of ordinary skill in the art of risk management and in view of the disclosure herein that the notion defining readiness as a preferred end-state of preparedness activities, that defining ready as a function of planning, training, investing, and exercise outcomes, and using a computerized system to facilitate such work are novel concepts.

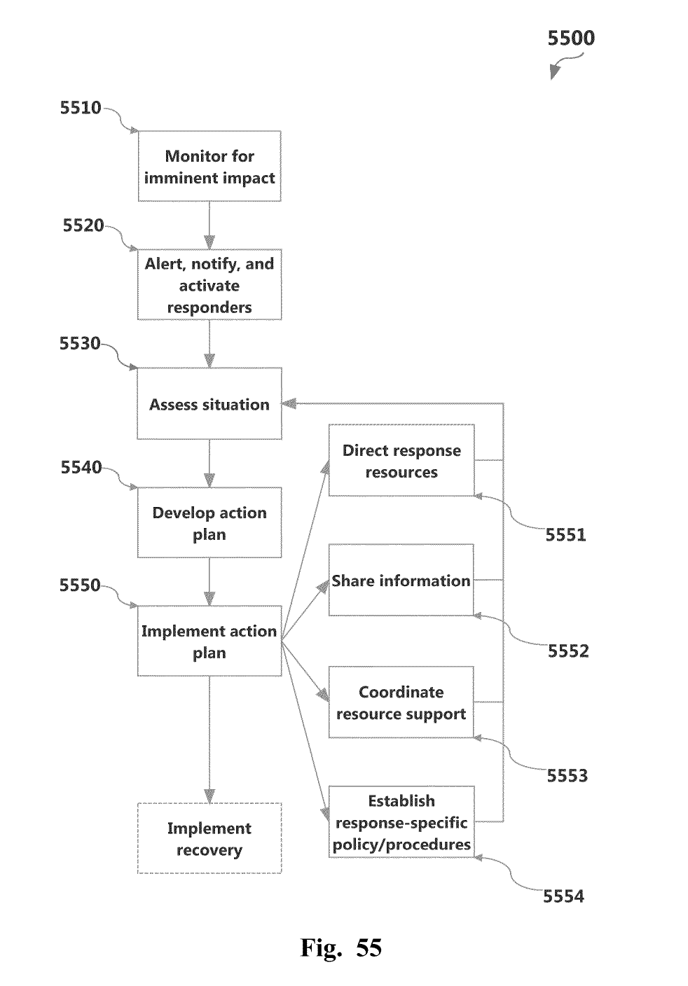

Response is the phase of risk management activity that ideally occurs after a risk management program has established itself, performed necessary hazard/threat assessment, developed a risk reduction (mitigation) plan, mitigated risk that can be mitigated, and prepared to respond to the risk that remains. Response involves addressing imminent hazard/threat impacts or impacts as they occur (i.e., fire-related threats to life, safety, health, and property). FIG. 55 is a block flow diagram that illustrates the overall process of response. It can be characterized by discrete activities to monitor for indications of hazard/threat impacts 5510; alert and notification of responders, other program stakeholders, and the public 5520; assessing conditions that necessitate response in order to organize and direct appropriate activities 5530; planning an effective response, either in whole or in part 5540; and implementation of action planning 5550. The implementation of a particular response plan or course of action involves activity to direct or coordinate resources 5551, sharing information among and between responders and those who directly or indirectly support response 5552; coordinating direct and indirect resource support for response 5553; and establishing response-specific policies and procedures 5554. It will be apparent to one of ordinary skill in the art of risk management and in view of the disclosure herein that several circumstances complicate the effective conduct of response activities, including:
a. The time when the onset of response-related impacts may occur is often unknown;
b. Impacts that require multi-agency response, by their very nature, typically exceed the resources or capability of any one agency or organization;
c. A vast and diverse array of responders and response agencies is typically required to effect an adequate response to large-scale events;
d. Agency or organization efforts to direct, control, coordinate or otherwise manage response are often decentralized;
e. Responders, response agencies and organizations respond or exercise response infrequently;
f. Response-specific processes and tools are not often adequate, in-place or ready to use; and
g. The need for timely, collaborative, secure and effective outcomes is often critical to success.

Computer-enabled incident management systems such as WebEOC and E Team have provided support for risk management response operations for over 10 years. Common characteristics of these systems are that they facilitate remote event management or coordination for a multitude of users, shared information and workspace, messaging, resource management and the use of geographic information systems to enhance visualization of response. However effective these systems have become for response, risk management organizations typically use them only a few days per year. This means that vital response tools remain unused and disconnected from users for as much as 99% of their time. Integration of these tools with information, processes and outcomes of the vast majority of work (the primary 99% of a risk manager's work) is virtually non-existent. For example, we are unable to find one such tool that links an incident management system to information about a hazard, various scenarios related to the hazard, vulnerabilities to the hazard or impacts that may be expected, plans, training, exercise results or relevant plan stakeholders. The current state of this art is limited to using rudimentary tools for response communication and coordination (i.e., messaging, event logging, limited resource tracking and referencing of job action sheets) and has failed to integrate the whole of risk management inputs, processes, and outputs. One preferred embodiment makes available the results of all hazard/threat assessments, outcomes, priorities, preparedness activities, stakeholder, and resource and project information during response. While existing incident management systems facilitate information sharing 5552 and resource coordination 5553, the need to integrate the outcomes of all phases into response activity is critical to success. It will be apparent to those of ordinary skill in the art of risk management and in view of the disclosure herein that the notion integrating the inputs, processes and outputs of all phases into response is a novel concept.

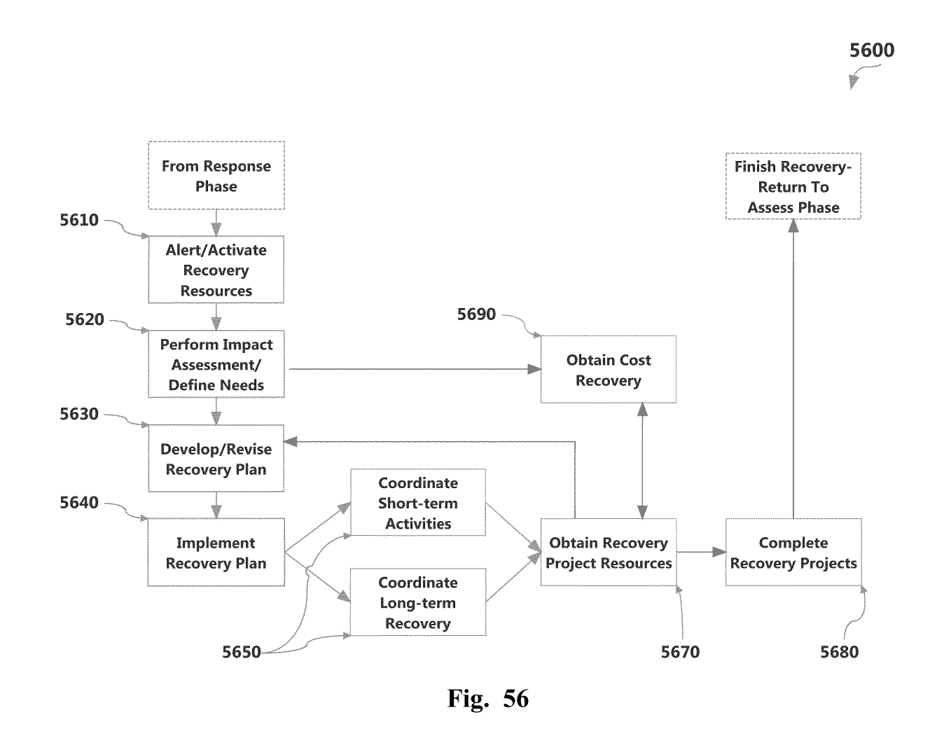

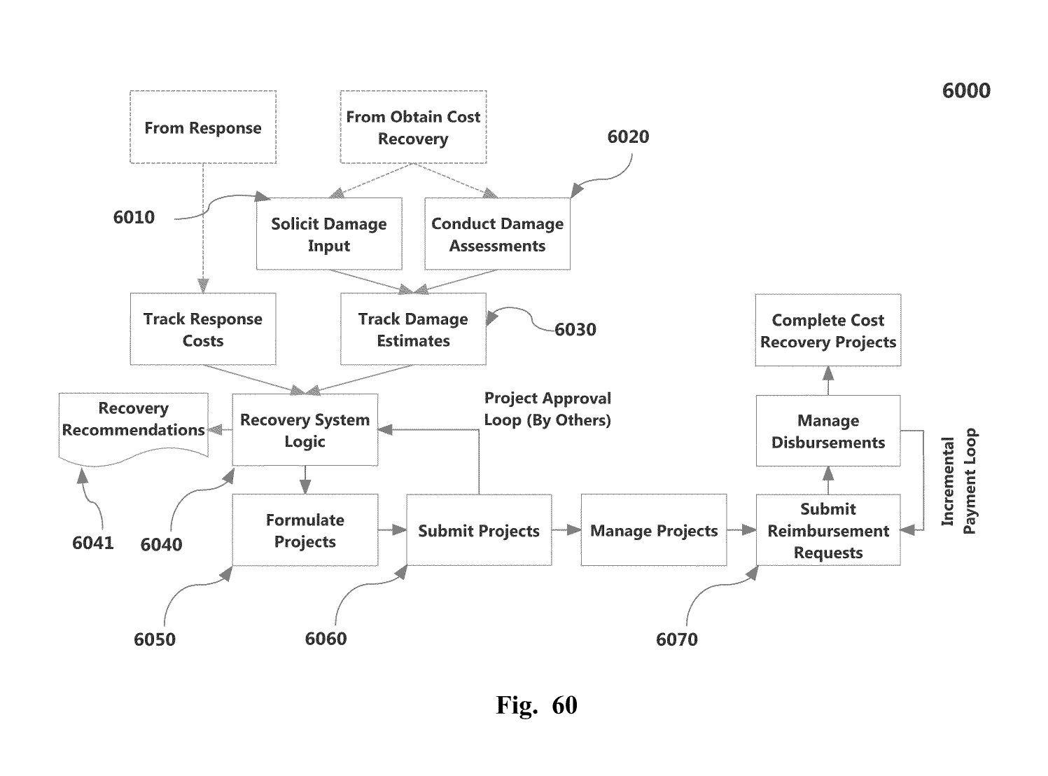

Recovery is the last phase of risk management before a risk management program cycles back to assess and mitigation phases to prepare for the next event. It involves efforts to return conditions to normal. Recovery activities begin as soon as possible, ideally as soon as response efforts begin to wane. Two primary goals of recovery are to return conditions to normal as soon as possible. Beginning this work early helps to capitalize on the surge of resources present during response, the attention of leaders, and other conditions which are conducive to clean-up, repair, replacement, etc. FIG. 56 is a block diagram that illustrates the recovery process. In a preferred embodiment, recovery personnel and resources are activated 5610 during the response phase to accomplish damage assessment and define recovery needs 5620. Part of the impact assessment may involve identifying costs associated with an event like damaged facilities, repair costs, regular time and overtime of response personnel, etc. At this stage of recovery it becomes important to collect costs 5690 which begins the cost recovery process. A recovery team then develops a recovery plan, preferably from a template or preliminary plan 5630 developed during the preparedness phase and specific to the needs of the event. The recovery team then implements the recovery plan 5640 and divides this work into short-term and long-term recovery activities (projects). Obtaining recovery resources 5670 is critical to the process and involves obtaining extraordinary funding, and may include obtaining assistance from one or more cost recovery processes 5690. To facilitate management of each recovery project, the coordination of resources for all recovery projects and to enhance cost recovery, projects may be divided by area, type of project, geographic area or other convention. As projects are completed 5680 risk management organizations return to the Assess phase to determine how vulnerability and potential impacts may be reduced before a subsequent event occurs. FIG. 60 is a block diagram that illustrates the cost recovery process in more detail. Data for event-related costs can be generated from both response and recovery phases. During response, the extraordinary cost of response itself (i.e., overtime, fuel, response equipment, the cost of response contractors, etc.) is tracked 6010 to report costs, describe immediate needs for funding and possibly to obtain cost recovery later. During response, damage assessment information can come from either external sources 6020 or internal sources that organize to complete a systematic damage assessment 6030. In one preferred embodiment, one or more users enter this information from any or all sources previously described and the system tracks, organizes, and executes recovery logic 6040 to develop recommendations for recovery actions 6041. Using this logic and by implementing the recommendations a user wishes to accept, the system generates projects 6050 in certain forms defined by users and, if necessary, for cost recovery approval organizations. The system then helps users to manage these projects as any other system project and helps to guide the user through the cost recovery process by providing guidance, developing specific documents for submittal 6060 and, if necessary, assisting by matching regular and cost-recovery project funding to the request-disbursement process 6070 of funding and recipient agencies. It will be apparent to those of ordinary skill in the art of risk management and in view of the disclosure herein that the notion automating, by means of computer process, the management of recovery projects, collection and tracking of response and recovery costs, development and implementation of recovery planning, and the facilitating the processes of cost recovery are novel concepts.

Implementing Information Technology—

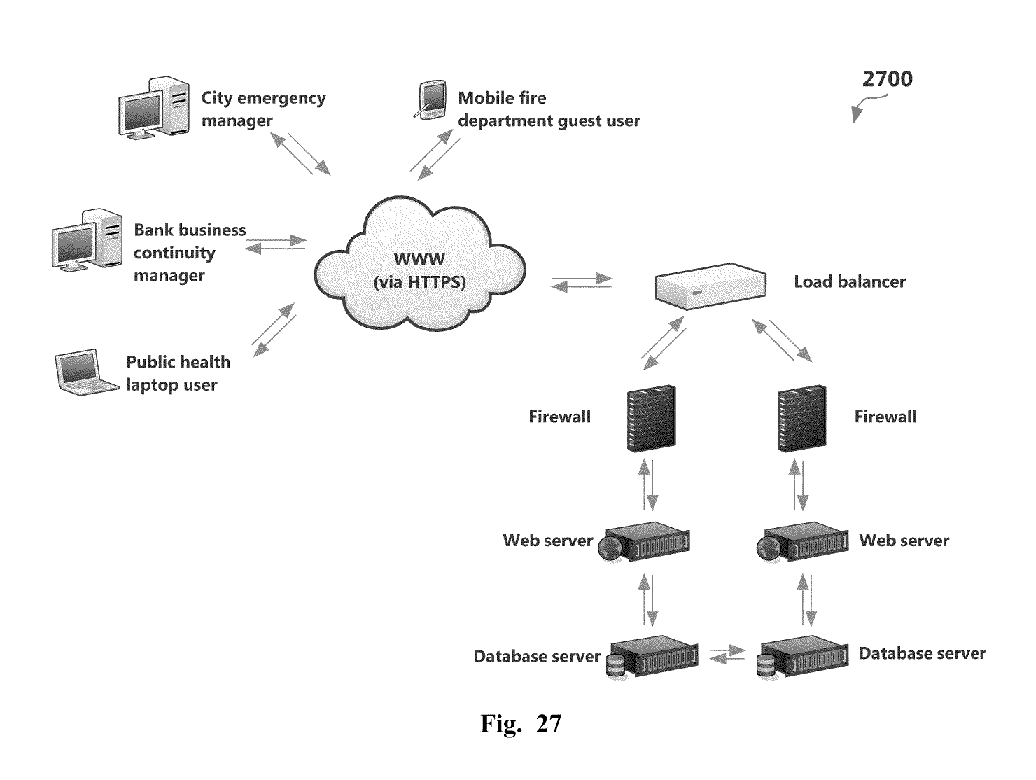

From an information technology, hardware, and software perspective, embodiments can occur as a:
a. Stand-alone computer solution;
b. LAN/WAN solution; or as a
c. Web-hosted solution.
   One preferred embodiment of this invention makes use of a computerized and responsive-design GUI, relational database management system, model-view-controller software architecture with a robust business logic layer, servers, routers and firewalls to deploy a hosted web solution. FIG. 27 illustrates a network design for this embodiment. Due to the sensitive nature of some risk management data, HTTP data exchange between the web server and active users would occur upon the SSL/TLS protocol. Additional security is provided by encrypting certain key elements of database tables. It will be apparent to those of ordinary skill in the art of risk management and in view of the disclosure herein that the notion of assessing, organizing, managing and accomplishing a comprehensive risk management program by using a computer aided system is a novel concept.

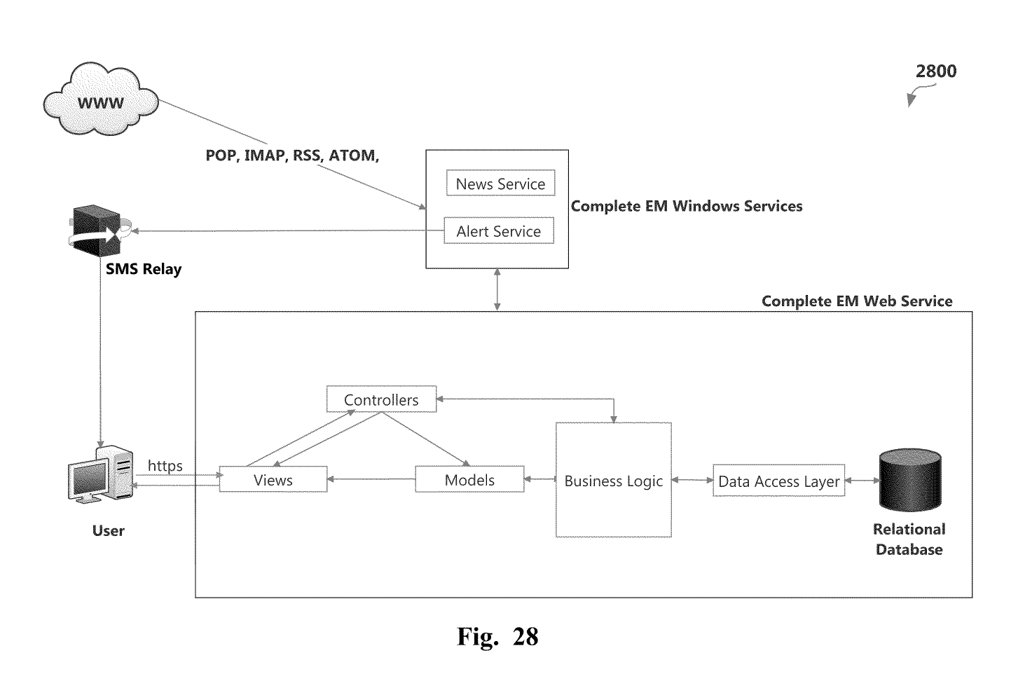

FIG. 28 illustrates one embodiment of this invention as a web-hosted SaaS. The Microsoft® ASP.NET software development framework is used to better ensure ongoing professional software support and to facilitate good integration with Microsoft Office® productivity software now used extensively by risk managers. However, the use of COM technology to exchange data between applications is becoming obsolete due the increasing use of XML. MVC architecture is used to implement a simple, easy-to-maintain and expanding programming convention and client-side technologies such as JavaScript and AJAX are used to enhance or reserve the server-side performance of the embodied network.

Views are designed using the ASP.NET MVC Razor Engine to render and edit HTML and CSS to facilitate easy changes to the look and feel of the website. Responsive page design techniques are used to ensure good user interface experiences on desktops, laptops, tablets, smart phones, and other mobile devices.

In accordance with this preferred embodiment, three primary categories of users are granted access to the SaaS: guest, subscriber and administrator. Guests are provided access to public pages. Subscribers are provided access to some number of secure pages and the applications they support, depending on a user's level of subscription. One or more subscription levels that grant access to different pages, depending on the subscription level, are made available as the SaaS administrator defines these levels. SaaS Administrators are provided access to all website pages. Subscribers are created through a self-registration process or can be created manually by an administrator. In either case, certain subscriber information such as the type of organization for which a subscriber is employed is collected. This data is then used to suggest a relevant set of program performance metrics and SaaS applications available for the user once they complete registration. FIG. 29 is a computer screenshot that illustrates the start of the SaaS user registration process.

Upon completion of a subscriber login via HTTPS; a user's program management dashboard view is rendered as a means to view all relevant program information and to allow any necessary program development capability embodied in the SaaS to be utilized. FIG. 8 is a block diagram that illustrates conceptual utility of the dashboard. FIG. 10 is a computer screenshot that illustrates one embodiment of the dashboard as seen by the SaaS user.

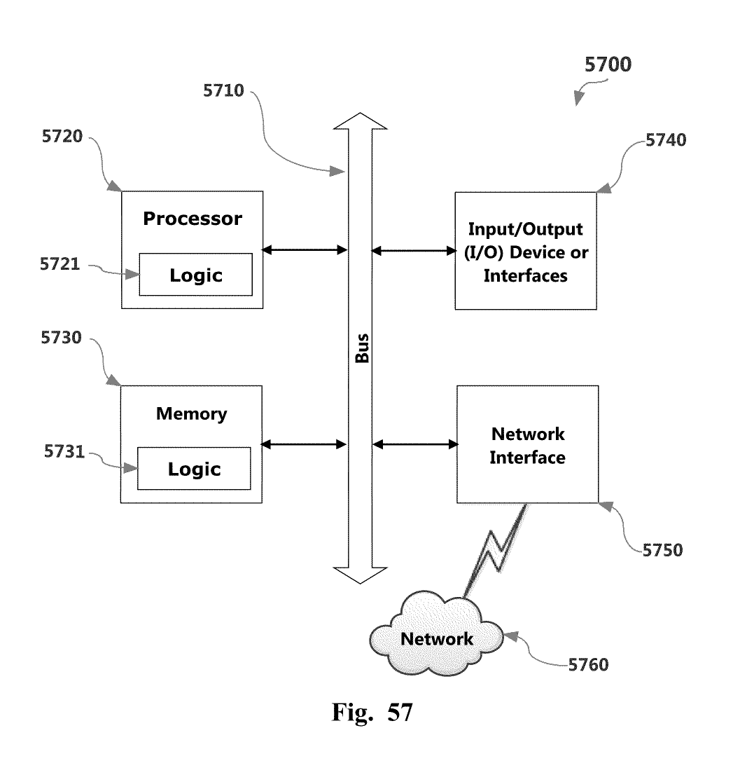

FIG. 57 illustrates a diagrammatic representation of a machine in the example form of a computing device and/or communication system within which a set of instructions when executed and/or processing logic is activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

FIG. 57 is a block diagram of a preferred embodiment consisting of a computing device and/or communication system that includes a data processor 5720 (e.g., a System-on-a-Chip (SoC), general processing core, graphics core, and optionally other processing logic) and a memory 5721, which can communicate with each other via a bus or other data transfer system 5710. The computing device and/or communication system may further include various input/output (I/O) devices and/or interfaces 5740, such as a touchscreen display, a keyboard or pointing device, and optionally a network interface 5750 In an example embodiment, the network interface 5750 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Cellular Digital Packet Radio (CDPD), Enhanced Data GSM Environment (EDGE), Wideband Code Division Multiple Access (WCDMA), LTE, CDMA2000, WLAN, Wireless Router (WR) mesh, and the like). Network interface 5750 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 5750 may include or support virtually any wired and/or wireless communication mechanisms by which information may travel between the computing device and/or communication system and another computing or communication system via network 5760.

The memory 5730 can represent a machine-readable medium on which is stored one or more sets of instructions, software, firmware, or other processing logic (e.g., logic 5730) embodying any one or more of the methodologies or functions described and/or claimed herein. The logic 5731, or a portion thereof, may also reside, completely or at least partially within the processor 5720 during execution thereof by the computing device and/or communication system. As such, the memory 5730 and the processor 5720 may also constitute machine-readable media. The logic 5731, or a portion thereof, may also be configured as processing logic or logic, at least a portion of which is partially implemented in hardware. The logic 5731, or a portion thereof, may further be transmitted or received over a network 5760 via the network interface 5750. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

I claim:

1. A method comprising:
deconstructing, by execution of a data processor, risk management program success into a collection of discrete risk management processes and outcomes;
identifying any number of required outcomes in the collection as well as factors that contribute to those outcomes;
assessing readiness of the risk management program by evaluating necessary outcomes;
prioritizing the necessary outcomes;
creating a strategic plan based on the prioritized outcomes;
developing a program work plan based on the strategic plan and the prioritized outcomes, the program work plan including a plurality of projects configured to produce the required outcomes and to accomplish the strategic plan; and
identifying the interdependencies between the plurality of projects.

2. The method as claimed in claim 1 including defining and managing one or more funding sources for each of the plurality of projects.

3. The method as claimed in claim 1 including managing each of the plurality of projects, in whole or in part by managing project details, status, tasks, activities, linkages to strategy, budgets, stakeholders, attachments and notes.

4. The method as claimed in claim 1 including tracking and calendaring the status of each of the plurality of projects, the status including time expended on one or more tasks.

5. The method as claimed in claim 1 including generating a plurality of discrete, custom, and computer-enabled program performance metrics and reports for different types of organizations, the plurality of metrics measuring and reporting the status and performance of each of the plurality of projects.

6. The method as claimed in claim 1 wherein the risk management program outcomes include hazard/threat outcomes, program element outcomes, capability outcomes, and relationship outcomes and each of these outcomes includes discrete attributes used to define, assess, track, relate, and manage outcomes.

7. The method as claimed in claim 1 wherein assessing risk management program success includes:
identifying a need for a particular outcome;
estimating the status of a particular outcome;
identifying gaps precluding a particular outcome;
developing strategies to close identified gaps;
defining an outcome sustainment strategy; and
organizing enterprise priorities, strategies, and work planning.

8. The method as claimed in claim 1 including identifying and displaying program development shortcomings, providing help, guiding program development efforts, and reminding risk managers of program development tasks that need to be performed.

9. The method as claimed in claim 1 including cataloging all risk management program inputs, processes and outputs.

10. The method as claimed in claim 1 including defining and tracking relationships between each of the risk management program attributes, inputs, interests, resources, processes, activities, and outputs.

11. The method as claimed in claim 1 including identifying and managing key stakeholders, relating key stakeholders to specific projects, strategies, priorities, and outcomes, and sending risk management program information to the key stakeholders.

12. The method as claimed in claim 1 wherein risk management program information is presented to a user utilizing a computer-generated dashboard via a graphical user interface (GUI) on a computing device including the data processor.

13. The method as claimed in claim 1 wherein risk management program information is automatically collected, aggregated, sorted, evaluated and disseminated as alerts, news, event information, and documents.

14. The method as claimed in claim 1 including generating risk management program documents by combining information from online user questionnaires or worksheets with maintained document templates to meet a specific document purpose, the method including developing mitigation plans, the mitigation plans including identifying risk, defining risk reduction measures, identifying projects and managing the implementation of those projects, the method including developing response plans, the response plans including monitoring for impacts, alerting responders, assessing situations, and implementing the response plans, the method including developing recovery plans, the recovery plans including performing impact assessments and alerting recovery resources, implementing the recovery plans, and effecting cost recovery, the method including development of other plans, procedures and reports pertinent to the practice of risk management.

15. The method as claimed in claim 1 including discrete steps, ongoing activities, and including automatically generating one or more metrics associated with a level of risk management program readiness.

16. The method as claimed in claim 1 wherein each of the collection of risk management outcomes can become a part of linear, iterative, and cyclical processes, the method further including:
establishing a program;
evaluating a program;
performing mitigation;
preparing for unmitigated risk;
responding to unmitigated risk impacts; and
recovering from risk-related impacts.

17. The method as claimed in claim 1 wherein organizing risk management program development efforts occurs by setting priorities, establishing a strategic plan, developing one or more work plans, and defining funding sources for program development work

18. The method as claimed in claim 1 wherein risk managers obtain assistance from a resource library, Wiki, community forum, point-to-point chat with other users, or contractors for hire.

19. The method as claimed in claim 1 wherein risk managers record time expended on any task and generate reports showing how this time has influenced program outcomes, priorities, goals, objectives, projects, funds, stakeholders, or schedules.

20. The method as claimed in claim 1 including executing risk management program development work by managing projects, funding, stakeholders, schedules, and phase-specific support including establishment, assessment, mitigation, preparedness, response, and recovery activity.

21. The method as claimed in claim 1 wherein readiness is defined as the preferred end-state of preparedness and that readiness consists of certain planning, training, investment exercise and evaluation outcomes related to a specific hazard/threat.
